(19) United States
(12) Patent Application Publication
(10) Pub. No.: US 2017/0138790 A1
(43) Pub. Date: May 18, 2017

(54) A method for determining the spectral scale of a spectrometer and apparatus

(71) Applicant: Spectral Engines Oy, Helsinki (FI)

(72) Inventors: Jarkko Antila, Helsinki (FI); Uula Kantojärvi, Helsinki (FI); Altti Akujärvi, Espoo (FI); Mikko Tuohiniemi, Espoo (FI); Jussi Mäkynen, Helsinki (FI)

(21) Appl. No.: 15/321,756

(22) PCT Filed: Jun. 29, 2015
(86) PCT No.: PCT/FI2015/050476

§ 371 Date: Dec. 23, 2016

(30) Foreign Application Priority Data
Jun. 27, 2014 (FI) 20145626

(51) Int. Cl. G01J 3/02; G01J 3/45; G01J 3/26

(52) U.S. Cl. CPC G01J 3/0297; G01J 3/26; G01J 3/0227; G01J 3/0286; G01J 3/45; G01J 3/027; G01J 3/0264; G01J 2003/2879

(57) ABSTRACT

A method for determining spectral calibration data (λ_{cal}(S_{d}), S_{d,cal}(λ)) of a Fabry-Perot interferometer (100) comprises:
forming a plurality of filtered spectral peaks (P′₁, P′₂) by filtering input light (LB1) with a Fabry-Perot etalon (50) such that a first filtered peak (P′₁) corresponds to a first transmittance peak (P₁) of the etalon (50), and such that a second filtered peak (P′₂) corresponds to a second transmittance peak (P₁) of the etalon (50),
using the Fabry-Perot interferometer (100) for measuring a spectral intensity distribution (M(S_{d})) of the filtered spectral peaks (P′₁, P′₂), wherein the spectral intensity distribution (M(S_{d})) is measured by varying the mirror gap (d_{FP}) of the Fabry-Perot interferometer (100), and by providing a control signal (S_{d}) indicative of the mirror gap (d_{FP}), and
determining the spectral calibration data (λ_{cal}(S_{d}), S_{d,cal}(λ)) by matching the measured spectral intensity distribution (M(S_{d})) with the spectral transmittance (T_{E}(λ)) of the etalon (50).

### FIELD

The present invention relates to a method for determining spectral calibration data of a Fabry-Perot interferometer. Some variations relate to spectral analysis of light. Further, the present invention relates to an apparatus.

### BACKGROUND

The wavelength scale of a Fabry-Perot interferometer can be calibrated e.g. by measuring the excitation spectrum of a gas discharge lamp. The gas discharge lamp may typically contain e.g. argon, neon, xenon, krypton, hydrogen, or mercury. The spectrum of the gas discharge lamp comprises a high number of atomic emission lines, which are characteristic to the gas contained in the lamp. However, gas discharge lamps are not available for all wavelength regions of interest. The spectral separation between atomic lines may sometimes be too narrow for accurate calibration. The spectral separation between atomic lines may sometimes be too large for accurate calibration. The calibration lamps consume electrical power. The calibration lamps may be fragile.

Document US 2004/070768 A1 discloses, for example, a wavelength reference apparatus for use in calibrating a tunable Fabry-Perot filter or a tunable VCSEL, whereby the device may be tuned to a precise, known wavelength, the wavelength reference apparatus comprising an LED, where the LED is chosen so as to have an emission profile which varies with wavelength. Further, the reference apparatus comprises an etalon, where the etalon is chosen so as to have a transmission profile which comprises a comb of transmission peaks, with each transmission peak occurring at a precise, known wavelength. Furthermore, the reference apparatus comprises a detector for detecting the light emitted by the LED and passing through the etalon. When a tunable Fabry-Perot filter or tunable VCSEL is positioned between the etalon and the detector, and the device is swept through its tuning range by varying the tuning voltage applied to the device, the known transmission wavelengths established by the LED and the etalon can be correlated to counterpart tuning voltages of the device, whereby to calibrate the device. The specific wavelengths of transmission peaks are a function of the etalon's substrate thickness and refractive index. The thickness of the etalon and the refractive index are configured such that very narrow transmission peaks are obtained which are located relatively close to each other.

Such a configuration is disadvantageous when calibrating mid-resolution devices such as MEM5 Fabry-Perot interferometer based devices. Two adjacent transmission peaks may be located too close to each other in order to unambiguously distinguish the peaks. For example, in case that the spectral resolution of a device is 10 nm and the specific wavelengths of transmission peaks of the etalon are spectrally 1 nm wide, about 90% of the signal power is lost compared to a case in which the specific wavelengths of transmission peaks of the etalon have spectral width of 10 nm. Thus, very narrow transmission peaks which are located relatively close to each other can increase the calibration time per device by the multiplier 100. Additionally, the signal power transmitted through the etalon is relatively small.

Therefore, it would be beneficial to provide a method for determining spectral calibration data of a Fabry-Perot interferometer and an apparatus, wherein calibration time can be reduced and the signal power transmitted through the etalon can be increased. Additionally, it would be beneficial to provide a method and apparatus by means of which variation of performance characteristics due to temperature changes can be considered, thus improving precision of calibration.

### SUMMARY

Some variations may relate to a method for calibrating a spectrometer. Some variations may relate to a method for measuring a spectrum. Some variations may relate to a spectrometer. Some variations may relate to a calibration device for calibrating a spectrometer. Some variations may relate to a computer program for calibrating a spectrometer. Some variations may relate to a computer program for measuring a spectrum. Some variations may relate to a computer program product, which comprises computer program code for calibrating a spectrometer. Some variations may relate to a computer program product, which comprises computer program code for measuring a spectrum.

According to a first aspect, there is provided a method according to claim 1.

According to a second aspect, there is provided an apparatus according to claim 11.

Further aspects are described in the dependent claims.

A method for determining spectral calibration data (λ_{cal}(S_{d}), S_{d,cal}(λ)) of a Fabry-Perot interferometer (100) may comprise:
forming a plurality of filtered spectral peaks (P′₁, P′₂) by filtering input light (LB1) with a Fabry-Perot etalon (50) such that a first filtered peak (P′₁) corresponds to a first transmittance peak (P₁) of the etalon (50), and such that a second filtered peak (P′₂) corresponds to a second transmittance peak (P₁) of the etalon (50),
using the Fabry-Perot interferometer (100) for measuring a spectral intensity distribution (M(S_{d})) of the filtered spectral peaks (P′₁, P′₂), wherein the spectral intensity distribution (M(S_{d})) is measured by varying the mirror gap (d_{FP}) of the Fabry-Perot interferometer (100), and by providing a control signal (S_{d}) indicative of the mirror gap (d_{FP}), and
determining the spectral calibration data (λ_{cal}(S_{d}), S_{d,cal}(λ)) by matching the measured spectral intensity distribution (M(S_{d})) with the spectral transmittance (T_{E}(λ)) of the etalon (50).

A method for verifying spectral calibration data (λ_{cal}(S_{d}), S_{d,cal}(λ)) of a Fabry-Perot interferometer (100) may comprise:
forming a plurality of filtered spectral peaks (P′₁, P′₂) by filtering input light (LB1) with a Fabry-Perot etalon (50) such that a first filtered peak (P′₁) corresponds to a first transmittance peak (P₁) of the etalon (50), and such that a second filtered peak (P′₂) corresponds to a second transmittance peak (P₁) of the etalon (50),
using the Fabry-Perot interferometer (100) for measuring a spectral intensity distribution (M(S_{d})) of the filtered spectral peaks (P′₁, P′₂), wherein the spectral intensity distribution (M(S_{d})) is measured by varying the mirror gap (d_{FP}) of the Fabry-Perot interferometer (100), and by providing a control signal (S_{d}) indicative of the mirror gap (d_{FP}), and
verifying the spectral calibration data (λ_{cal}(S_{d}), S_{d,cal}(λ)) by checking whether the measured spectral intensity distribution (M(S_{d})) matches with the spectral transmittance (T_{E}(λ)) of the etalon (50).

A spectrometer may comprise a Fabry-Perot interferometer and a detector for monitoring intensity of light transmitted through the Fabry-Perot interferometer. The Fabry-Perot interferometer may be used for measuring an intensity distribution by scanning the interferometer. The interferometer may be scanned by varying the mirror gap of the interferometer. The spectrometer may provide a control signal indicative of the mirror gap. The control signal may be provided e.g. by a control unit, and the mirror gap may be controlled according to the control signal. Alternatively, the control signal may be provided by monitoring the mirror gap, e.g. by using a capacitive sensor. The control signal may be e.g. a digital control signal or an analog control signal. Each spectral position may be associated with a control signal value such that the relationship between the spectral positions and the control signal values may be expressed by calibration data.

The spectral scale of the interferometer may be calibrated in order to perform accurate spectral analysis. Spectral calibration data of the interferometer may determine a relation for obtaining spectral positions from values of the control signal. The spectral calibration data may define the spectral scale of the interferometer. Each spectral position may be associated with a control signal value by using the spectral calibration data.

When monitoring an unknown spectrum, the spectrometer may be arranged to obtain intensity values from the detector as a function of the control signal. The measured intensity values may be associated with calibrated spectral positions by using the spectral calibration data. The spectral calibration data may comprise e.g. parameters of a regression function, which defines the relationship between each spectral position and the control signal value corresponding to said spectral position. The spectral calibration data may be stored e.g. in a memory of the spectrometer, and/or in a database server.

The Fabry-Perot interferometer comprises a first semi-transparent mirror and a second semi-transparent mirror, which are arranged to form an optical cavity of the interferometer. The Fabry-Perot interferometer may provide a narrow transmission peak, which has adjustable spectral position, and which can be used for spectral analysis. The spectral position of the transmission peak may be changed by changing the distance between the mirrors. The distance between mirrors may be called e.g. as the mirror gap or as the mirror spacing. The Fabry-Perot interferometer may have adjustable mirror gap.

The spectral position of the transmittance peak may be changed according to the control signal. The control signal may be e.g. a voltage signal, which is applied to a piezoelectric actuator of the Fabry-Perot interferometer in order to change the mirror gap of the Fabry-Perot interferometer. The control signal may be e.g. a voltage signal, which is applied to electrodes of an electrostatic actuator in order to change the mirror gap of the Fabry-Perot interferometer.

In an embodiment, the control signal may also be provided by a sensor. The control signal may indicate e.g. capacitor value of a capacitive sensor, which is arranged to monitor the mirror gap of the Fabry-Perot interferometer.

The relationship between each spectral position of the transmission peak and the control signal value corresponding to said spectral position may depend e.g. on the operating temperature of the Fabry-Perot interferometer. Said relationship may depend on the operating life (i.e. age) of the interferometer. Said relationship may be substantially changed e.g. if the interferometer experiences an impact (i.e. an acceleration shock). Said relationship may be substantially changed e.g. due to chemical corrosion.

A Fabry-Perot etalon may be arranged to form a plurality of filtered spectral peaks. Fabry-Perot interferometer may be used for measuring the spectral intensity distribution of the filtered spectral peaks. The spectral calibration data of the interferometer may be determined by matching the peaks of the measured distribution with the peaks of the spectral transmittance of the etalon. The spectral calibration data of the interferometer may be checked by comparing the measured distribution with the spectral transmittance of the etalon. The measured distribution may be matched with the spectral transmittance e.g. by using cross-correlation. The spectral calibration data may be checked by using cross-correlation analysis.

The spectral calibration data may be determined by matching spectral features of the measured spectral distribution with spectral features of the spectral transmittance of the etalon.

The spectral calibration data may be determined by matching spectral peaks of the measured spectral distribution with spectral peaks of the spectral transmittance of the etalon.

The spectral calibration data may be determined such that the measured spectral distribution matches with the spectral transmittance of the etalon, when the relation between the control signal and the spectral position is determined by using said spectral calibration data.

The spectral calibration data may be determined such that spectral features of the measured spectral distribution substantially coincide with spectral features of the spectral transmittance of the etalon, when the relation between the control signal and the spectral position is determined using said spectral calibration data.

The spectral calibration data may be determined such that the spectral position of a first spectral feature of the measured spectral distribution substantially coincides with the spectral position of a first spectral feature of the spectral transmittance of the etalon, when the relation between the control signal and the spectral position is determined using said spectral calibration data, and such that the spectral position of a second spectral feature of the measured spectral distribution substantially coincides with the spectral position of a second spectral feature of the spectral transmittance of the etalon, when the relation between the control signal and the spectral position is determined using said spectral calibration data,

The etalon may be placed in the optical path of the spectrometer. The etalon may provide a simple and highly stabile spectral reference for calibration and/or for measurement purposes. The spectral scale of the spectrometer may be stabilized by using a Fabry-Perot etalon, which has fixed mirror spacing.

Input light may be filtered by using a Fabry-Perot etalon in order to provide a plurality of spectral peaks. Said spectral peaks may be called e.g. as reference peaks or as filtered peaks. The etalon may comprise a substrate, which has a first planar surface and a second planar surface. The first planar surface and the second planar surface may be flat. The second planar surface is parallel to the first planar surface. The distance between the planar surfaces may be called as the mirror spacing of the etalon. The planar surfaces may form an optical cavity, which causes constructive and destructive interference such that broadband input light transmitted through the planar surfaces may have a plurality of the spectral reference peaks. The spectral position of transmittance peaks of the Fabry-Perot etalon may be highly stable.

The spectral position of transmittance peaks of the Fabry-Perot etalon may mainly depend on the mirror spacing of the etalon. The mirror spacing of the etalon may be substantially constant. The mirror spacing of the etalon may be substantially independent of air pressure, variations of humidity, ageing, and/or corrosion. The mirror spacing of the etalon may remain constant even after a mechanical impact. The mirror spacing of the etalon may have highly reproducible thermal expansion.

The Fabry-Perot etalon may have highly stable monolithic structure. The monolithic structure may be mechanically and thermally stabile. The monolithic etalon may be more stable than an etalon, where the reflectors are separated by an air gap. The mirror spacing of the etalon may be defined by the thickness of a substrate of the etalon. In that case, the stability of the etalon may mainly depend on the thermal stability of the substrate. In that case, the mirror spacing of the etalon may mainly depend on the magnitude of temperature variation and on the coefficient of thermal expansion (CTE) of the substrate. For example, the substrate may be silicon. For example, when the substrate is silicon and when the temperature of the substrate is monitored with an accuracy, which is better than 2° C., the wavelength stability may be better than 0.01 nm at the wavelength of 2 μm. In practice, the stability of the spectral scale may be e.g. better than 1 ppm. The coefficient of thermal expansion of silicon is approximately 2.6·10⁻⁶/° C. The stability of the spectral scale may be e.g. better than 1 ppm (= 1/10⁶). The deviation λ(S_{d1})−λ_{P1} between a determined wavelength λ(S_{d1}) and the true wavelength λ_{P1} may be smaller than 10⁻⁶·λ_{P1}.

In an embodiment, the spectral positions of the reference peaks may depend on the temperature of the substrate of the etalon, but the spectral positions of the reference peaks may be accurately determined based on temperature of the substrate. The temperature of the substrate may be monitored by a temperature sensor. The spectral positions of the reference peaks may be accurately known as a function of the temperature of the substrate. The temperature of the substrate of the etalon may be optionally monitored by a temperature sensor. The sensor may be implemented e.g. by a thermocouple, Pt100 sensor, or by a P-N junction.

In an embodiment, a Fabry-Perot spectrometer may be calibrated by using a light source unit, which comprises the etalon. In an embodiment, a spectroscopic apparatus may comprise a light source unit, the etalon, and the Fabry-Perot interferometer.

In an embodiment, the spectral scale of a spectrometer may be determined and/or verified when measuring an unknown spectrum of an object. The spectral calibration data may be determined and/or verified by using light received from said object. The spectral calibration may be performed on-line, when measuring the unknown spectrum of the object. The etalon may be e.g. temporarily positioned between the object and the spectrometer, or the spectrometer may permanently comprise the etalon. Spectral stability may be a key parameter when analyzing spectra by the spectrometer. By using the etalon, the spectral scale may be stabilized even when the spectrometer is used in a harsh environment. A highly stable spectrometer may be provided by combining the scanning Fabry-Perot interferometer with the etalon. The etalon may be easily integrated in an on-line measurement system. In an embodiment, a Fabry-Perot spectrometer may comprise a permanently attached etalon for providing reference peaks.

The operation of the etalon as such does not require operating power. However, optional monitoring the temperature of the etalon may sometimes require a very low power.

Calibration by using an etalon may be used at various different wavelength regions, by selecting the material of the substrate and the optional coatings of the planar reflective surfaces of the etalon. By using the etalon, several reference peaks may be provided to cover a wide portion of the detection range of the spectrometer. In an embodiment, several reference peaks may be provided to cover substantially the whole detection range of the spectrometer.

In an embodiment, light may be coupled into a spectrometer by using one or more optical fibers.

In an embodiment, a light source unit may comprise the etalon, and calibration light provided by a light source unit may be coupled into a spectrometer for determining and/or checking the spectral scale of a spectrometer. In an embodiment, calibration light from a single light source unit may be distributed to several spectrometers in order to calibrate the spectral scales of said spectrometers substantially simultaneously. The calibration may be performed e.g. during production of the spectrometers. In an embodiment, even thousands of interferometers may be calibrated at a factory rapidly and/or with relatively low costs.

In an embodiment, the calibration light provided by a light source unit may be simultaneously distributed to a plurality of spectrometers by using optical fibers.

The calibration of the spectrometer may optionally comprise intensity calibration in addition to the spectral calibration. The intensity values of the spectrometer may be calibrated e.g. by measuring spectral intensity values of light obtained from a blackbody radiator or a tungsten ribbon lamp, and by comparing the measured spectral intensity values with intensity calibration data associated with said radiator or lamp.

The spectrometer may be used for analyzing spectra of samples e.g. in the pharmaceutical industry, in the beverage industry, in the food industry, or in petrochemical industry. The sample may comprise e.g. food, beverage, medicament, or a substance for producing a medicament.

Certain embodiments provide a method for determining spectral calibration data of a Fabry-Perot interferometer and an apparatus, wherein calibration time can be reduced and the signal power transmitted through the etalon can be increased. Additionally, certain embodiments provide a method and apparatus by means of which variation of performance characteristics due to temperature changes can be considered, thus improving precision of calibration.

### BRIEF DESCRIPTION OF THE DRAWINGS

In the following examples, several variations will be described in more detail with reference to the appended drawings, in which

FIG. 1 shows, by way of example, a spectrometer, which comprises a Fabry-Perot interferometer,

FIG. 2 shows, by way of example, the spectral transmittance of a Fabry-Perot interferometer and a spectrum of light received from an object,

FIG. 3a shows, by way of example, a light source unit,

FIG. 3b shows, by way of example, the spectral transmittance of an etalon, a spectrum of filtered peaks, and a measured spectral intensity distribution,

FIG. 3c shows, by way of example, a system for spectral calibration of a spectrometer,

FIG. 4a shows, by way of example, control signal values corresponding to the spectral positions of the transmission peaks of the etalon,

FIG. 4b shows, by way of example, a calibration function for obtaining spectral positions from control signal values,

FIG. 5 shows, by way of example, a spectrometer, which comprises a Fabry-Perot interferometer, and an etalon,

FIG. 6a shows, by way of example, forming a filtered spectrum by using the etalon,

FIG. 6b shows, by way of example, forming a calibrated measured spectrum from the measured distribution of FIG. 6a,

FIG. 6c shows, by way of example, method steps for determining calibration data,

FIG. 7 shows, by way of example, a measurement system, which comprises a light source, a spectrometer, and an etalon,

FIG. 8a shows, by way of example, forming a filtered absorption spectrum,

FIG. 8b shows, by way of example, determining a calibrated absorption spectrum from the measured distribution of FIG. 8a,

FIG. 9 shows, by way of example, a measurement system, which comprises a light source, a spectrometer, and an etalon, and

FIG. 10 shows, by way of example, a Fabry-Perot interferometer, which comprises an electrostatic actuator, and

FIG. 11 shows, by way of example, a Fabry-Perot interferometer, which comprises a capacitive sensor for monitoring the mirror gap.

### DETAILED DESCRIPTION

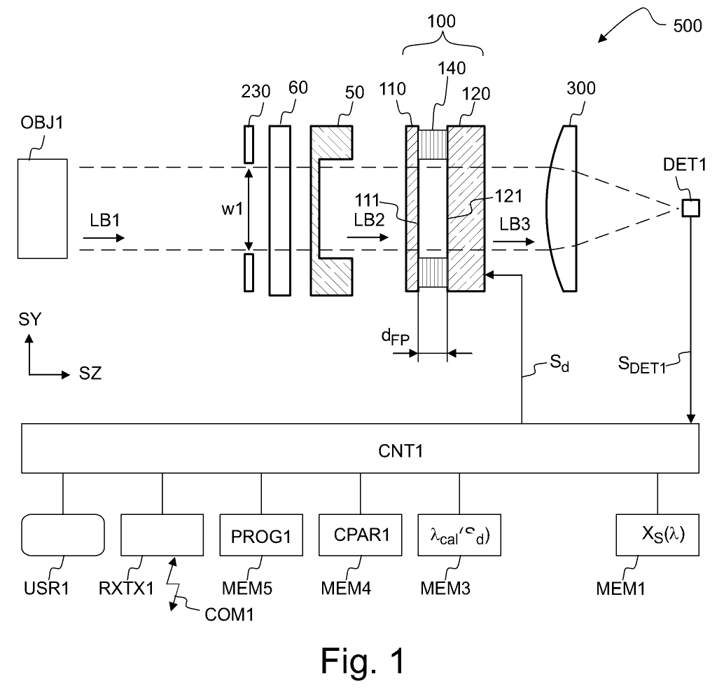

Referring to FIG. 1, a spectrometer 500 may comprise a Fabry-Perot interferometer 100 and a detector DET1. An object OBJ1 may reflect, emit and/or transmit light LB1. The light LB1 may be coupled into the spectrometer 500 in order to monitor the spectrum of the light LB1.

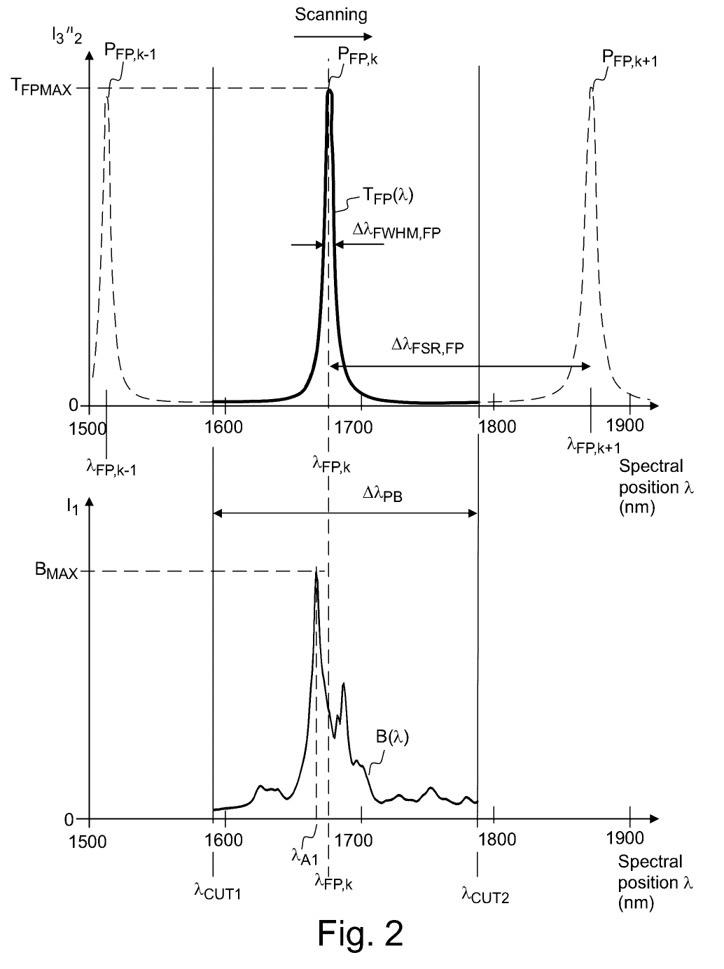

The Fabry-Perot interferometer 100 comprises a first semi-transparent mirror 110 and a second semi-transparent mirror 120. The distance between the first mirror 110 and the second mirror 120 is equal to a mirror gap d_{FP}. The mirror gap d_{FP} may be adjustable. The first mirror 110 may have a solid-gas interface 111, and the second mirror 121 may have a solid-gas interface 121. The mirror gap d_{FP} may denote the distance between the interfaces 111 and 121. The Fabry-Perot interferometer 100 may provide a transmission peak P_{FP,k} (FIG. 2), wherein the spectral position of the transmission peak P_{FP,k} may depend on the mirror gap d_{FP}. The spectral position of the transmission peak P_{FP,k} may be changed by changing the mirror spacing d_{FP}. The transmission peak P_{FP,k} may also be called as the passband of the Fabry-Perot interferometer 100.

The spectrometer 500 may comprise one or more filters 60 to define a detection band Δλ_{PB} of the spectrometer 500. The filter 60 may provide filtered light LB2 by filtering the light LB1 received from the object OBJ1.

The Fabry-Perot interferometer 100 may form transmitted light LB3 by transmitting a portion of the filtered light LB2 to the detector DET1. Transmitted light LB3 obtained from interferometer 100 may be coupled to the detector DET1. The transmitted light LB3 may at least partly impinge on the detector DET1.

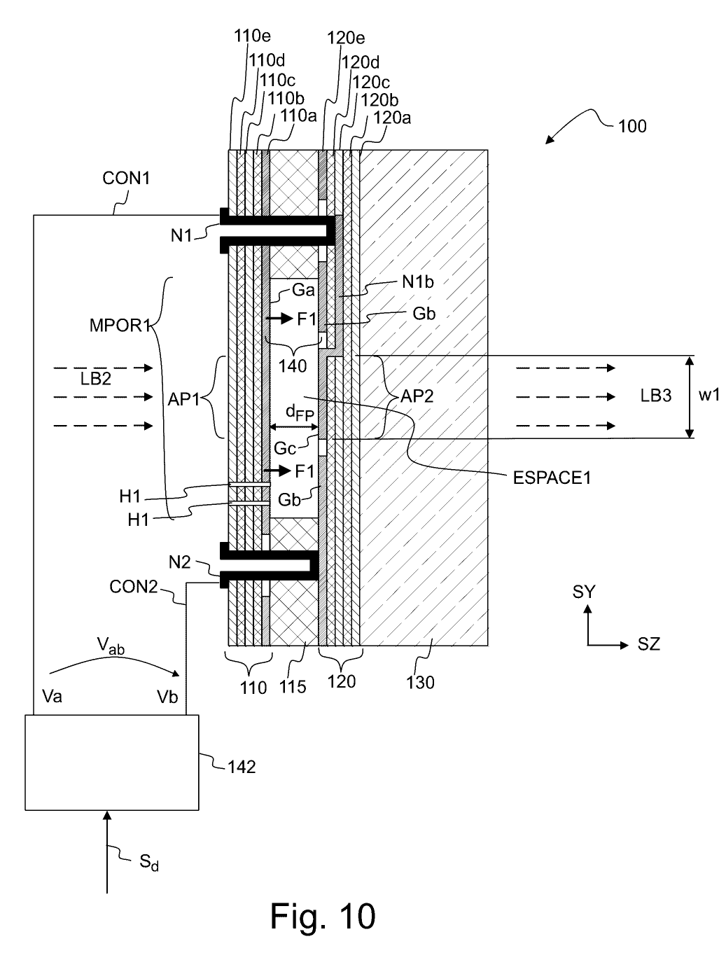

An actuator 140 may be arranged to move the first mirror 110 with respect to the second mirror 120. The actuator 140 may be e.g. an electrostatic actuator (FIG. 10), or a piezoelectric actuator. The mirrors 110, 120 may be substantially flat and substantially parallel to each other. The semi-transparent mirrors 110, 120 may comprise e.g. a metallic reflective layer and/or a reflective dielectric multilayer. One of the mirrors 110, 120 may be attached to a frame, and the other mirror may be moved by the actuator 140.

The light LB1 may be obtained from an object OBJ1. For example, the light LB1 may be emitted from the object, the light LB1 may be reflected from the object, and/or the light LB1 may be transmitted through the object. The spectrum of the light LB1 may be measured e.g. in order to determine emission spectrum, reflectance spectrum, and/or absorption spectrum of the object OBJ1.

The object OBJ1 may be e.g. a real or virtual object. For example, the object OBJ1 may be a tangible piece of material. The object OBJ1 may be a real object. The object OBJ1 may be e.g. in solid, liquid, or gaseous form. The object OBJ1 may comprise a sample. The object OBJ1 may a combination of a cuvette and a chemical substance contained in the cuvette. The object OBJ1 may be e.g. a plant (e.g. tree or a flower), a combustion flame, or an oil spill floating on water. The object may be e.g. the sun or a star observed through a layer of absorbing gas. The object OBJ1 may be a display screen, which emits or reflects light of an image. The object OBJ1 may be an optical image formed by another optical device. The object OBJ1 may also be called as a target.

The light LB1 may also be provided e.g. directly from a light source, by reflecting light obtained from a light source, by transmitting light obtained from a light source. The light source may comprise e.g. an incandescent lamp, a blackbody radiator, an infrared light emitting glow-bar, a tungsten halogen lamp, a fluorescent lamp, or a light emitting diode. The mirror gap d_{FP} of the interferometer 100 may be varied according to the control signal S_{d}. For example, the mirror gap d_{FP} may be adjusted by converting the control signal S_{d} into driving voltage, which is applied to the actuator 140 of the interferometer 100. Alternatively, the mirror gap d_{FP} may be monitored e.g. by a capacitive sensor, which may provide the control signal S_{d}.

The spectrometer 500 may comprise a control unit CNT1. The control unit may comprise one or more data processors. The control unit CNT1 may be arranged to provide a control signal S_{d} for controlling the mirror spacing d_{FP} of the interferometer 100. For example, the spectrometer 500 may comprise a driving unit, which may be arranged to convert a digital control signal S_{d} into a voltage signal V_{ab}. The voltage signal V_{ab} may be coupled to a piezoelectric actuator or to en electrostatic actuator in order to adjust the mirror gap d_{FP} (FIG. 10). The control signal S_{d} may be indicative of the mirror gap d_{FP}. In an embodiment, the control signal S_{d} may be proportional to the voltage signal V_{ab} coupled to the actuator. The driving unit may convert a digital signal S_{d} into an analog signal suitable for driving the actuator.

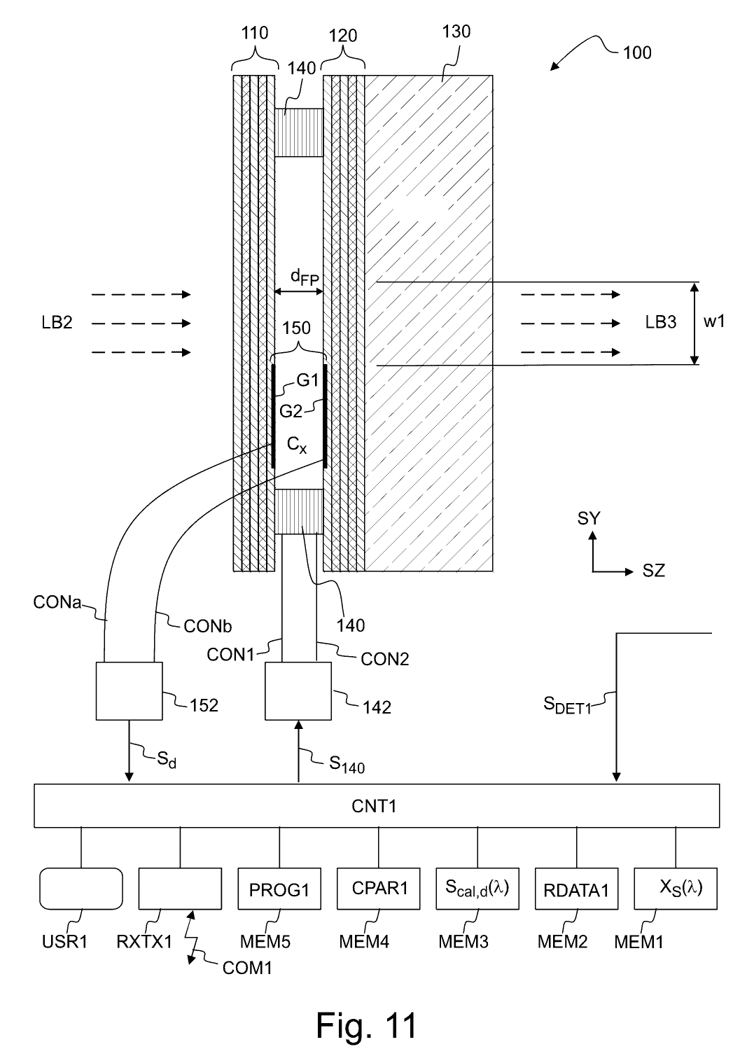

The control signal S_{d} may also be a sensor signal. The interferometer may comprise e.g. a capacitive sensor for monitoring the mirror gap d_{FP} (FIG. 11). The capacitive sensor may be arranged to provide the control signal S_{d} by monitoring the mirror gap d_{FP}. The control signal S_{d} may be used as a feedback signal indicative of the mirror spacing d_{FP}.

The spectrometer 500 may optionally comprise light concentrating optics 300 for concentrating light into the detector DET1. The optics 300 may comprise e.g. one or more lenses and/or one or more reflective surfaces (e.g. a paraboloid reflector). The optics 300 may be positioned before the interferometer 100. The optics 300 may be positioned after the interferometer 100 (i.e. between the interferometer 100 and the detector DET1). One or more components of the optics 300 may be positioned before the interferometer 300, and one or more components of the optics 300 may be positioned after the interferometer.

The detector DET1 may be arranged to provide a detector signal S_{DE1}. The detector signal S_{DET1} may be indicative of the intensity I₃ of light LB3 impinging on the detector DET1. The detector DET1 may convert the intensity I₃ of light LB3 impinging on the detector DET1 into a detector signal value S_{DET1}.

The detector DET1 may be sensitive e.g. in the ultraviolet, visible and/or infrared region. The spectrometer 500 may be arranged to measure spectral intensities e.g. in the ultraviolet, visible and/or infrared region. The detector DET1 may be selected according to the detection range of the spectrometer 500. For example, the detector may comprise e.g. a silicon photodiode. The detector may comprise a P-N junction. The detector may be a pyroelectric detector. The detector may be a bolometer. The detector may comprise a thermocouple. The detector may comprise a thermopile. The detector may be an Indium gallium arsenide (InGaAs) photodiode. The detector may be a germanium photodiode. The detector may be a photoconductive lead selenide (PbSe) detector. The detector may be a photoconductive Indium antimonide (InSb) detector. The detector may be a photovoltaic Indium arsenide (InAs) detector. The detector may be a photovoltaic Platinum silicide (PtSi) detector. The detector may be an Indium antimonide (InSb) photodiode. The detector may be a photoconductive Mercury cadmium telluride (MCT, HgCdTe) detector. The detector may be a photoconductive Mercury zinc telluride (MZT, HgZnTe) detector. The detector may be a pyroelectric Lithium tantalate (LiTaO3) detector. The detector may be a pyroelectric Triglycine sulfate (TGS and DTGS) detector. The detector DET1 may be an imaging detector or a non-imaging detector. The detector may comprise one or more pixels of a CMOS detector. The detector may comprise one or more pixels of a CCD detector.

The spectrometer 500 may comprise a memory MEM4 for storing intensity calibration data CPAR1. One or more intensity values I₁ of the light LB1 may be determined from the detector signals SDET1 by using the intensity calibration data CPAR1. The intensity calibration data CPAR1 may comprise e.g. one or more parameters of a regression function, which allows determining intensity values I₁ of the light LB1 from the detector signal values S_{DET1}.

Spectral calibration data may determine a relation between values of the control signal S_{d} and spectral positions λ. A calibration function λ_{cal}(S_{d}) may determine a relation for obtaining spectral positions λ from values of the control signal S_{d}. Spectral calibration data may comprise parameters of a function λ_{cal}(S_{d}), which gives spectral position λ as the function of the control signal S_{d}.

Spectral calibration data S_{d,cal}(λ) may determine a relation for obtaining values of the control signal S_{d} from spectral positions λ. Spectral calibration data may comprise parameters of a function S_{d,cal}(λ) which gives control signal S_{d} as the function of the spectral position λ.

Each determined intensity value 1₁ may be associated with a value of the control signal S_{d}, and the determined intensity value 1₁ may be associated with a spectral position λbased on said control signal value S_{d} and spectral calibration data.

Each measured detector signal value S_{DET1} may be associated with a value of the control signal S_{d}, and the detector signal value S_{DET1} may be associated with a spectral position λ based on the control signal value S_{d} and spectral calibration data.

The spectrometer 500 may comprise a memory MEM3 for storing spectral calibration data. The spectral calibration data λ_{cal}(S_{d}) may comprise e.g. one or more parameters of a regression function, which allows determining the relationship between control signal values S_{d} and spectral positions λ. The spectrometer 500 may be arranged to determine spectral positions λ from control signal values S_{d} by using the spectral calibration data. The spectrometer 500 may comprise a memory MEM5 for storing a computer program PROG1. The computer program PROG1 may be configured, when executed by one or more data processors (e.g. CNT1), to determine spectral positions λ from control signal values S_{d} by using the spectral calibration data. The spectrometer 500 may be arranged to obtain detector signal values S_{DET1} from the detector DET1, and to determine intensity values I₁ from the detector signal values S_{DET1} by using the intensity calibration data CPAR1. The computer program PROG1 may be configured, when executed by one or more data processors (e.g. CNT1), to obtain detector signal values S_{DET1} from the detector DET1, and to determine intensity values I₁ from the detector signal values S_{DET1} by using the intensity calibration data CPAR1.

The spectrometer 500 may optionally comprise a memory MEM1 for storing spectral data λ_{S}(λ).The spectral data λ_{S}(λ) may comprise e.g. intensity values I₁ determined as a function I₁(λ) of the spectral position λ. The spectral data λ_{S}(λ) may comprise a calibrated measured spectrum I₁(λ). The spectral data λ_{S}(λ) may comprise e.g. detector signal values S_{DET1} determined as a function S_{DET1}(λ) of the spectral position λ.

The spectrometer 500 may optionally comprise a user interface USR1 e.g. for displaying information and/or for receiving commands. The user interface USR1 may comprise e.g. a display, a keypad and/or a touch screen.

The spectrometer 500 may optionally comprise a communication unit RXTX1. The communication unit RXTX1 may transmit and/or receive a signal COM1 e.g. in order to receive commands, to receive calibration data, and/or to send spectral data. The communication unit RXTX1 may be capable of wired and/or wireless communication. For example, the communication unit RXTX1 may be capable of communicating with a local wireless network (WLAN), with the Internet and/or with a mobile telephone network.

The spectrometer 500 may be implemented as a single physical unit or as a combination of separate units. In an embodiment, the interferometer 100, and the units CNT1, MEM1, MEM3, MEM4, MEM5, USR1, RXTX1 may be implemented in the same housing. In an embodiment, the spectrometer 500 may be arranged to communicate detector signals S_{DET1} and control signals S_{d} with a remote data processing unit, e.g. with a remote server. Spectral positions λ may be determined from the control signals S_{d} by the remote data processing unit.

The spectrometer 500 may optionally comprise one or more optical cut-off filters 60 to limit the spectral response of the detector DET1. The filters 60 may define the detection band of the spectrometer 500. The filters 60 may be positioned before and/or after the interferometer 100.

The spectrometer 500 may optionally comprise e.g. a lens and/or an aperture 230, which is arranged to limit the divergence of the light LB3 transmitted through the interferometer 100 to the detector DET1, in order to provide a narrow bandwidth Δλ_{FP} of the transmission peak P_{FP,k}. For example, the divergence of the light LB3 may be limited to be e.g. smaller than or equal to 10 degrees. When using light concentrating optics 300, the divergence of light LB3 contributing to the spectral measurement may also be limited by the dimensions of the detector DET1.

SX, SY and SZ denote orthogonal directions. The light LB2 may propagate substantially in the direction SZ. The mirrors 110, 120 of the interferometer may be substantially perpendicular to the direction SZ. The directions SZ and SY are shown in FIG. 1. The direction SX is perpendicular to the plane of drawing of FIG. 1.

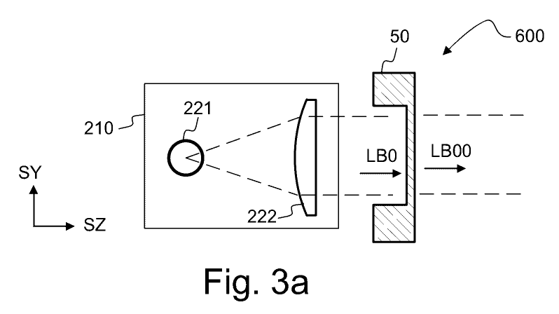

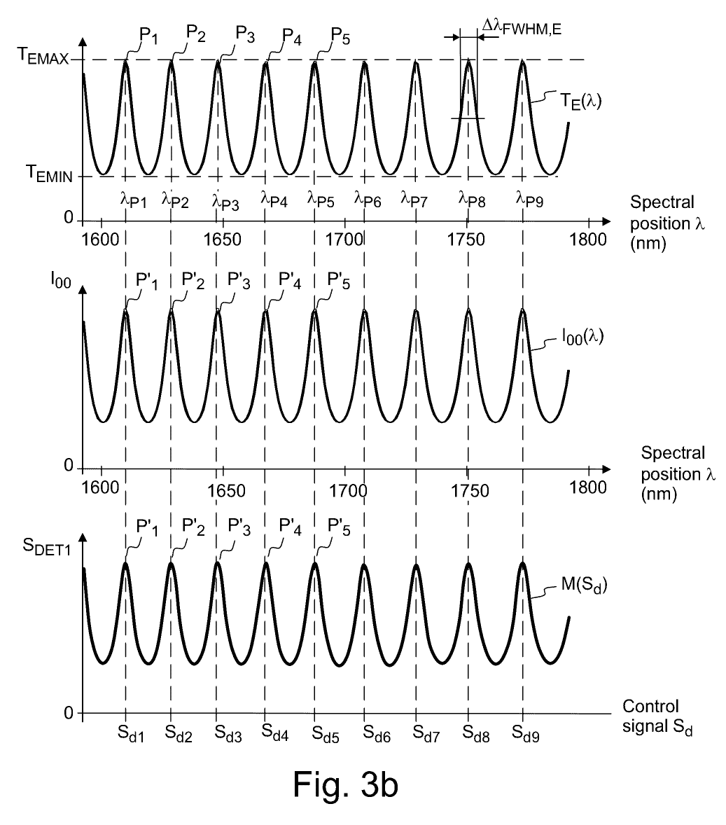

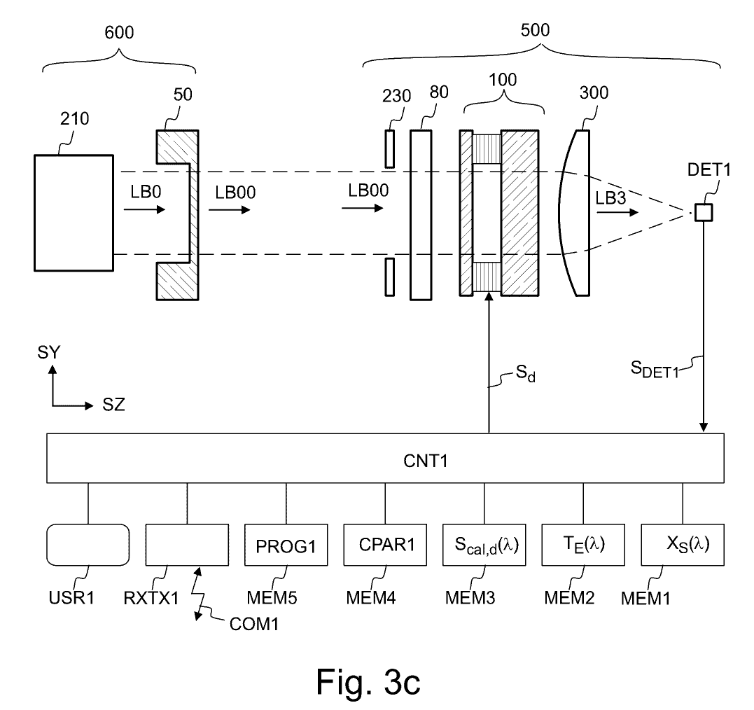

The spectrometer of FIG. 1 may comprise a Fabry-Perot etalon 50 for determining and/or verifying the spectral scale of the interferometer. For example, the system of FIG. 3c, 5, 7, or 9 may comprise the spectrometer of FIG. 1.

The Fabry-Perot etalon 50 may be, for example, formed using silicon on insulator (SOI) technology. The Fabry-Perot etalon 50 and the Fabry-Perot interferometer 100 may be, for example, formed using micro-electro-mechanical system (MEM5) technology. Typically, the Fabry-Perot etalon 50 is configured such that the specific wavelengths of transmission peaks of the etalon 50 and the spectral resolution of the system are synchronized. Thus, adjacent transmission peaks can be located in order to unambiguously distinguish the peaks. According to certain embodiments, the transmitted signal power in the blocking bands may be, for example, in the range between 1% and 30% of the original signal power.

FIG. 2 shows, by way of example, the spectral transmittance T_{FP}(λ) of a Fabry-Perot interferometer 100, and the spectrum B(λ) of light LB1 received from an object OBJ1. The spectral transmittance T_{FP}(λ) of the interferometer 100 may have a plurality of transmission peaks PF_{P,k-1}, P_{FP,k}, P_{FP,k+1}, . . . at respective spectral positions λ_{FP,k-1}, λ_{FP,k}, λ_{FP,k+1}. The spectrometer 500 may be arranged to detect light LB3 transmitted by a predetermined peak P_{FP,k}. The spectral position λ_{FP,k} of the transmission peak P_{FP,k} may be adjusted by changing the mirror gap d_{FP}.

The spectrometer 500 may comprise one or more cut-off filters 60 to define a detection band Δλ_{PB} of the spectrometer 500. The spectrometer 500 may be arranged to operate such that the spectrometer 500 is substantially insensitive to spectral components, whose wavelengths are outside a detection range Δλ_{PB}. The detection range Δλ_{PB} may be defined e.g. by a bandpass or cut-off filter 60, which rejects wavelengths which are shorter than a first cut off value λ_{CUT1} and longer than a second cut off value λ_{CUT2}. The filter unit 60 may be implemented by using one or more optical filters. For example, the filter unit 60 may be implemented by stacking two or more cut-off filters. The filters 60 may block wavelengths outside the detection band Δλ_{PB} from reaching the detector DET1. A cut-off filter 60 may prevent spectral components at wavelengths λ shorter than a first cut-off limit λ_{CUT1} from impinging on the detector DET1. A cut-off filter 60 may prevent spectral components at wavelengths λ longer than a second cut-off limit λ_{CUT1}, λ_{CUT2} from impinging on the detector DET1. The cut-off limits _{λCUT1}, λ_{CUT2} may be selected such that only spectral components within the detection range Δλ_{PB} propagate to the detector DET1, depending on the spectral position λ_{FP,k} of the transmission peak P_{FP,k} of the interferometer 100. The cut-off limits λ_{CUT1}, λ_{CUT2} may be selected such that spectral components overlapping the other transmission peaks λ_{FP,k-1}, λ_{FP,k+1} do not propagate to the detector DET1. Adjacent peaks P_{FP,k}, P_{FP,k+1} of the interferometer 100 are separated by the free spectral range Δλ_{FSR,FP}. The cut-off limits λ_{CUT1}, λ_{CUT2} may be selected such that the detection range Δλ_{PB} of the spectrometer 500 is narrower than the free spectral range Δλ_{FSR,FP}. Wavelengths outside the detection range Δλ_{PB} may also be rejected by utilizing spectral selectivity of the detector DET1 and/or another optical component of the spectrometer. The filters 60 may be omitted e.g. when the detector DET1 is not sensitive to light outside the range refined by the cut-off limits λ_{CUT1}, λ_{CUT2}. The filters 60 may be omitted when the input light LB1 does not contain spectral components at wavelengths outside the range defined by the cut-off limits λ_{CUT1}, λ_{CUT2}.

I₂(λ) may denote spectral intensity of light LB2 impinging on the interferometer 100, and I₃(λ) may denote spectral intensity of light LB3 transmitted through the interferometer 100. The spectral transmittance T_{FP}(λ) means the ratio I₃(λ)/I₂(λ).

The lowermost curve of FIG. 2 shows an input spectrum B(λ). The input spectrum B(λ) may also be called as the spectral intensity distribution I₁(λ) of the input light LB1. The spectrum B(λ) may have a maximum value B_{MAX}. The spectral transmittance of the peak P_{FP,k} may have a maximum value T_{FP,MAX}. The maximum value B_{MAX} of the input spectrum B(λ) may be attained e.g. at a spectral position λ_{A1}.

Referring to FIG. 3a, a light source unit 210 and a Fabry-Perot etalon 50 may together form a calibration light unit 600, which may be arranged to provide calibration light LB00.

The light source unit 210 may comprise a light source 221, and optionally a light-directing element 222. The light source 221 may comprise e.g. an incandescent lamp, a blackbody radiator, an infrared light emitting glow-bar, a tungsten halogen lamp, a fluorescent lamp, or a light emitting diode. The light-directing element 222 may comprise e.g. a lens or a paraboloid reflector. The light source unit 210 may be arranged provide illuminating light LB0. The Fabry Perot etalon 50 may be arranged to provide filtered light LB00 by filtering the illuminating light LB0. The illuminating light LB0 may have a broad spectrum, and the filtered light LB00 may have a comb-like spectral intensity distribution I₀₀(λ), corresponding to the spectral transmittance T_{E}(λ) of the etalon 50.

FIG. 3b shows how the spectral peaks of the calibration light LB00 may be formed by using the etalon 50.

The uppermost curve of FIG. 3b shows, by way of example, the spectral transmittance T_{E}(λ) of the etalon 50. The second curve from the top shows a spectrum of the calibration light LB00. The lowermost curve shows a measured spectral intensity distribution M(S_{d}) of the calibration light LB00. T_{EMAX} denotes the maximum value of spectral transmittance T_{E}(λ).T_{EMIN} denotes the minimum value of spectral transmittance T_{E}(λ).

The spectral transmittance T_{E}(λ) is equal to the relative fraction of incident light at a specified wavelength that passes through the etalon 50. When generating calibration light LB00 by filtering with the etalon 50, the spectral transmittance T_{E}(λ) may be equal to the ratio I₀₀(λ)/I₀(λ), where I₀(λ) denotes the spectral intensity of the illuminating light LB0, and I₀₀(λ) denotes the spectral intensity of the filtered light LB00.

The spectral transmittance T_{E}(λ) of the etalon 50 comprises a plurality of transmittance peaks P₁, P₂, P₃, . . . Each transmittance peak P₁, P₂, P₃, . . . may have a peak wavelength λ_{P1}, λ_{P2}, λₚ₃, . . . The etalon 50 may have a plurality of adjacent transmission peaks P1, P2, P3, . . . at the wavelengths λ_{P1}, λ_{P2}, λ_{P3}, . . . The detection range Lλ_{PB} of the spectrometer 500 may comprise e.g. three or more transmission peaks P1, P2, P3, . . .

The transmission peaks P1, P2, P3 may have a spectral width Δλ_{FWHM,E}. The acronym FWHM means full width at half maximum.

Referring to the second curve from the top, the etalon 50 may form a plurality of filtered spectral peaks P′₁, P′₂, P′₃, P′₄, P′₅, . . . by filtering illuminating light LB0 such that a first filtered peak P′₁ corresponds to a first transmittance peak P₁ of the etalon 50, and a second filtered peak P′₂ corresponds to a second transmittance peak P₁ of the etalon 50. The spectrum I₀₀(λ) of the calibration light LB00 may have a plurality of filtered spectral peaks P′₁, P′₂, P′₃, P′₄, P′₅, . . . The spectral positions of the filtered spectral peaks P′₁, P′₂, P′₃, P′₄, P′₅, . . . may substantially coincide with the spectral positions λp₁, λ_{P2}, λp₃, . . . of transmittance peaks of the etalon 50.

Referring to the lowermost curve of FIG. 3b, the interferometer 100 may be arranged to provide a measured distribution M(S_{d}). The distribution M(S_{d}) may contain a plurality of data points such that each data point contains a measured detector signal value S_{DET1} and a corresponding control signal value S_{d}. The distribution M(S_{d}) may specify measured detector signal values S_{DET1} as a function of the control signal S_{d}. The distribution M(S_{d}) may be called e.g. as the measured detector signal distribution. The detector signal S_{DET1} may be indicative of the spectral intensity. Consequently, the distribution M(S_{d}) may also be called as the measured spectral intensity distribution. The distribution M(S_{d}) may be provided by recording detector signal values as the function of the control signal S_{d}.

The spectral intensity distribution M(S_{d}) may be measured by scanning the interferometer 100 over the filtered spectral peaks P′₁, P′₂, P′₃, P′₄, P′₅, . . . The spectral intensity distribution M(S_{d}) may be measured by varying the mirror gap d_{FP} and by recording the detector signal S_{DET1} as the function of the control signal S_{d}. The spectral intensity distribution M(S_{d}) may be measured by varying the mirror gap d_{FP} of the Fabry-Perot interferometer 100 according to a control signal S_{d}, or by varying the mirror gap d_{FP} of the Fabry-Perot interferometer 100 and providing the control signal S_{d} by monitoring the mirror gap.

Spectral calibration data for the interferometer 100 may be determined by matching the measured spectral intensity distribution M(S_{d}) with the spectral transmittance T_{E}(λ) of the etalon (50).

A first peak P1 of the spectral transmittance T_{E}(λ) may have a spectral position λp₁, and a second peak P2 of the spectral transmittance T_{E}(λ) may have a spectral position λ_{P2}. A first filtered peak P′₁ of the distribution M(S_{d}) corresponds to the first transmittance peak P₁ of the etalon 50, and a second filtered peak P′₂ of the distribution M(S_{d}) corresponds to the second transmittance peak P₂ of the etalon 50. The first filtered peak P′₁ of the measured distribution M(S_{d}) may coincide with a first control signal value S_{d1}, and the second filtered peak P′₂ of the measured distribution M(S_{d}) may coincide with a second control signal value S_{d2}. Consequently, the first control signal value S_{d1} may be associated with the spectral position λp₁, and the second control signal value S_{d2} may be associated with the second control signal value S_{d2}.

Referring to FIG. 3c, the calibration light LB00 may be coupled into the spectrometer 500 in order to determine and/or check spectral calibration data. The etalon 50 may provide filtered calibration light LB00 by filtering input light LB0. The filtered light LB00 may comprise a plurality of filtered peaks corresponding to the spectral transmittance of the etalon 50. The spectral scale of the interferometer 100 may be verified and/or determined by using the interferometer 100 for measuring a spectral intensity distribution of the filtered peaks. The spectral intensity distribution of the filtered peaks may be measured by scanning the transmission peak P_{FP,k} of the interferometer 100 over the spectrum I₀₀(λ) of the calibration light LB00. The spectral scale of the interferometer 100 may be determined by matching the measured spectral intensity distribution M(S_{d}) with the spectral transmittance of the etalon 50.

The spectral intensity distribution M(S_{d}) may be measured by scanning the interferometer 100. During the scanning, the mirror gap d_{FP} may be varied according to the control signal S_{d}, or the spectrometer may provide a control signal S_{d} by monitoring the mirror gap d_{FP}. The spectral intensity distribution M(S_{d}) may be measured by varying the mirror gap d_{FP} and by recording the detector signal S_{DET1} as the function of the control signal S_{d}.

The spectrometer 500 may comprise a memory MEM2 for storing information about the spectral transmittance T_{E}(λ) of the etalon 50. For example, the memory MEM2 may comprise data, which numerically defines the spectral transmittance function T_{E}(λ). For example, the memory MEM2 may comprise data, which specifies the spectral positions λ_{P1}, λ_{P2}, λp₃, . . . of the transmittance peaks of the etalon 50.

The combined transmittance of the Fabry-Perot etalon 50 and the Fabry-Perot interferometer 100 may be proportional to the intensity I₃ of light LB3 impinging on the detector DET1. The combined transmittance may be monitored by monitoring the intensity I₃ of light LB3 impinging on the detector DET1. The detector signal S_{DET1} of the detector DET1 may be indicative of the intensity I₃ of light LB3 impinging on the detector DET1. The mirror gap d_{FP} may be varied and the combined transmittance may be monitored in order to determine a first control signal value S_{d1} associated with a first mirror gap d_{FP} when the transmission peak P_{FP,k} of the interferometer 100 substantially coincides with a first filtered spectral peak P′₁ of the calibration light LB00. The mirror gap d_{FP} may be varied and the combined transmittance may be monitored in order to determine a second control signal value S_{d2} associated with a second mirror gap d_{FP} when the transmission peak P_{FP,k} of the interferometer 100 substantially coincides with a second filtered spectral peak P₂ of the calibration light LB00.

The calibration function λ_{cal}(S_{d}) and/or S_{d,cal}(λ) may be determined by matching the measured distribution M(S_{d}) with the transmittance function T_{E}(λ), wherein the matching may comprise associating control signal values with spectral positions. The first filtered spectral peak P′₁ has a spectral position λ_{P1}, and the second filtered spectral peak P′₂ has a spectral position λ_{P2}. The spectral position λ_{P1} and the first control signal value S_{d1} may be associated to form a first pair (λ_{P1}, S_{d1}). The spectral position λ_{P2} and the second control signal value S_{d2} may be associated to form a second pair (λ_{P2}, S_{d2}). Spectral calibration data λ_{cal}(S_{d}) and/or S_{d,cal}(λ) may be determined by using the first pair (λ_{P1}, S_{d1}) and the second pair (λ_{P2}, S_{d2}). Additional pairs (λ_{P3}, S_{d3}), (λ_{P4}, S_{d4}), . . . may be formed based on the spectral positions of the other filtered spectral peaks. The spectral calibration data λ_{cal}(S_{d}) of the interferometer (100) may be determined also by using the additional pairs (λp₃, S_{d3}), (4₄, S_{d4}),

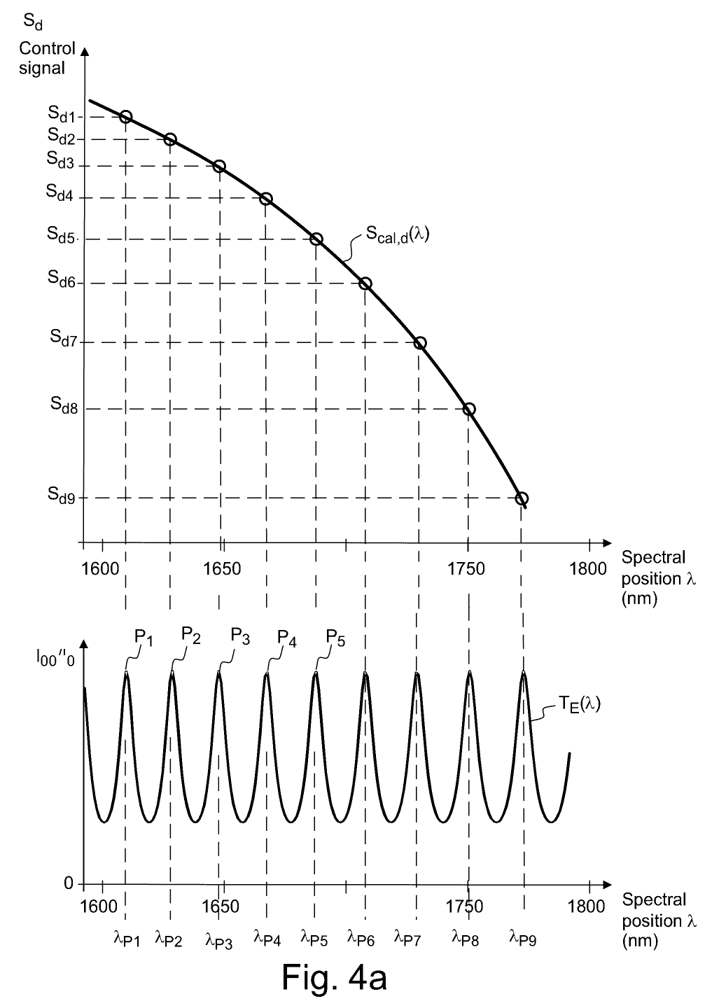

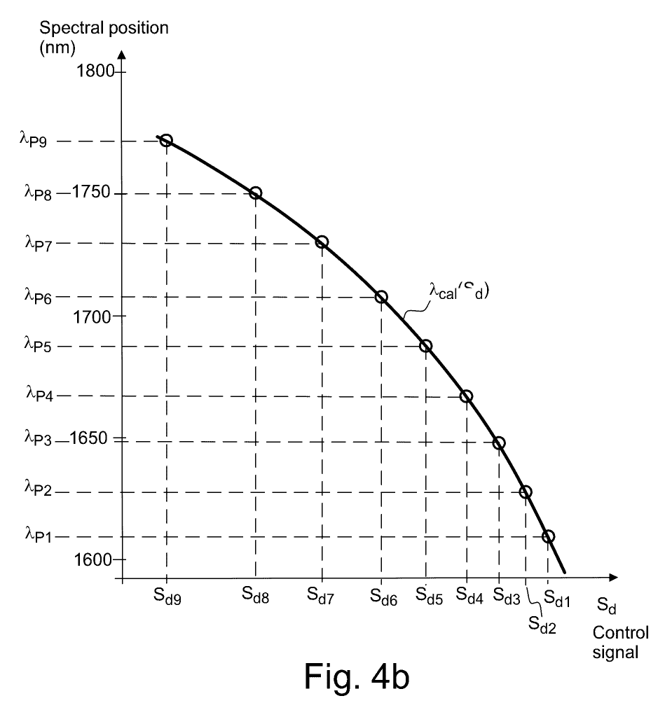

FIG. 4a shows, by way of example, calibration data S_{cal,d}(λ), which defines a relation between spectral positions λ and corresponding control signal values Sd.

A first control signal value S_{d1} may be associated with a first mirror gap d_{FP} in a situation where the spectral position of the transmission peak P_{FP,k} of the interferometer 100 coincides with the spectral position λ_{P1} of a first transmittance peak P1 of the etalon 50. A second control signal value S_{d2} may be associated with a second mirror gap d_{FP} in a situation where the spectral position of the transmission peak P_{FP,k} of the interferometer 100 coincides with the spectral position λ_{P2} of a second transmittance peak P2 of the etalon 50. A third control signal value S_{d3} may be associated with a third mirror gap d_{FP} in a situation where the spectral position of the transmission peak P_{FP,k} of the interferometer 100 coincides with the spectral position λp₃ of a third transmittance peak P3 of the etalon 50. Values (S_{d4}, λ_{P4}), (S_{d5}, λ_{P5}), (S_{d6}, λ_{P6}), (S_{d7}, λ_{P7}), (S_{d8}, λ_{P8}), (S_{d9}, λ_{P9}) may be paired, respectively.

The relationship between the spectral positions λ and the corresponding control signal values S_{d}(λ) may be expressed e.g. by a calibration function S_{cal,d}(λ). The relationship between the control signal values S_{d}(λ) and the corresponding spectral positions λmay be expressed e.g. by a calibration function λ_{cal}(S_{d}).

FIG. 4b shows, by way of example, a calibration function λ_{cal}(S_{d}). The calibration function λ_{cal}(S_{d}) may give the spectral position λas the function of the control signal value S_{d}. The calibration function S_{d,cal}(λ) may give the control signal value S_{d} as the function of the spectral position λ. The calibration function λ_{cal}(S_{d}) may be the inverse function of the calibration function S_{d,cal}(λ). When the calibration function S_{d,cal}(λ) has been determined, the calibration function λ_{cal}(S_{d}) may be subsequently determined from the calibration function S_{d,cal}(λ). If the calibration function λ_{cal}(S_{d}) has been determined, the calibration function S_{d,cal}(λ) may be subsequently determined from the calibration function λ_{cal}(S_{d}).

The calibration function λ,(S_{d}) and/or S_{d,cal}(λ) may be determined e.g. by fitting a regression function to a plurality of data points (λᵢ, S_{d} j) wherein the spectral positions of said data points (λᵢ, S_{d} j) may substantially coincide with the spectral positions λ_{P1}, λ_{P2}, λₚ₃, . . . of the transmission peaks P1, P2, P3, . . . of the etalon 50. Spectral calibration data λ_{cal}(S_{d}) and/or S_{d,cal}(λ) may comprise e.g. a regression function, which may be fitted to the data pairs (λ_{P1}, S_{d1}), (λ_{P2}, S_{d2}), (λ_{P3}, S_{d3}), (λ_{P4}, S_{d4}),.. The calibration function S_{d,cal}(λ) may be e.g. a polynomial function. The calibration function S_{d,cal}(λ) may be e.g. a third order polynomial function.

The calibration function λ_{cal}(S_{d}) and/or S_{d,cal}(λ) or a look-up-table corresponding to the calibration function λ_{cal}(S_{d}) and/or S_{d,cal}(λ) may be stored in a memory MEM3 of the spectrometer 500 and/or in a memory of a database server. When needed, the calibration data may be retrieved from the memory. The calibration data may be used for determining the spectral scale for a measured spectrum. The calibration data may be verified and/or modified. Modified calibration data may be optionally stored in a memory MEM3 of the spectrometer 500 and/or in a memory of a database server, again.

The transmittance T_{E}(λ) of the etalon 50 may, in turn, be calibrated e.g. by using a monochromator, by using a Fourier transform infrared spectrometer and/or by comparing the transmittance T_{E}(λ) with the spectral positions of emission lines of a calibration lamp (based on atomic line emission).

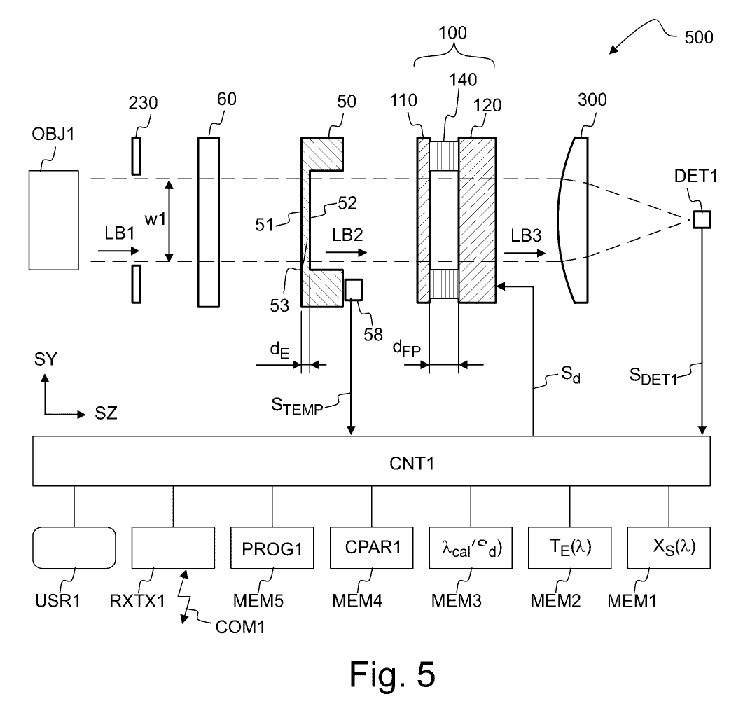

The spectral width Δλ_{FWHM,E} of the transmittance peaks P₁, P₂, P₃ may depend on the reflectivity of the planar surfaces 51, 52, and on the mirror spacing d_{E} of the etalon 50 (FIG. 5). The surfaces 51, 52 may be flat. The minimum transmittance of the etalon 50 may be determined by the reflectivity of the planar surfaces 51, 52. The reflectivity and the mirror spacing of the etalon 50 may be selected according to the detection range Δλ_{PB} of the spectrometer 500 and/or according to the spectrum, which is to be measured by the spectrometer 500. The mirror spacing of the etalon 50 may be selected to provide a suitable number of transmittance peaks P₁, P₂, P₃, . . . within the detection range Δλ_{PB} of the spectrometer 500. The spectral widths Δλ_{FWHM,E} of the transmittance peaks P₁, P₂, P₃, . . . may be selected according to the spectral width Δλ_{FWHM,FP} of the transmission peak P_{FP} of the Fabry-Perot interferometer 100. The planar surfaces 51, 52 may be semi-reflective. The etalon 50 may comprise a substrate 53, which has the planar surfaces 51, 52. For example, the substrate 53 may consist of fused silica. For example, the substrate 53 may consist of monocrystalline silicon. For example, the substrate 53 may consist essentially of of fused silica. For example, the substrate 53 may consist essentially of monocrystalline silicon.

The planar surfaces 51, 52 of the etalon 50 may be optionally coated with semi-reflective coatings. The planar surfaces of the etalon 50 may be implemented by using semi-reflective coatings. The etalon 50 may comprise semi-reflective coatings. The reflectivity of the coatings may be selected to provide a suitable spectral width Δλ_{FWHM,E}. However, the etalon 50 may also be implemented without reflective coatings. The surfaces 51, 52 may operate as semi-reflective mirrors based on the difference between the refractive index of the substrate 53, and the refractive index of the surrounding gas.

Referring to FIG. 5, the spectrometer 500 may comprise the etalon 50, which may be arranged to provide filtered light LB2 by filtering input light LB1. In particular, the etalon 50 may be arranged to provide filtered light LB2 also during measuring the (unknown) spectrum B(λ) of input light LB1 received from an object OBJ1. In an embodiment, the etalon 50 may be permanently positioned in the optical path of the spectrometer 500. The etalon 50 may be positioned e.g. between the object OBJ1 and the interferometer 100, or between the interferometer 100 and the detector DET1.

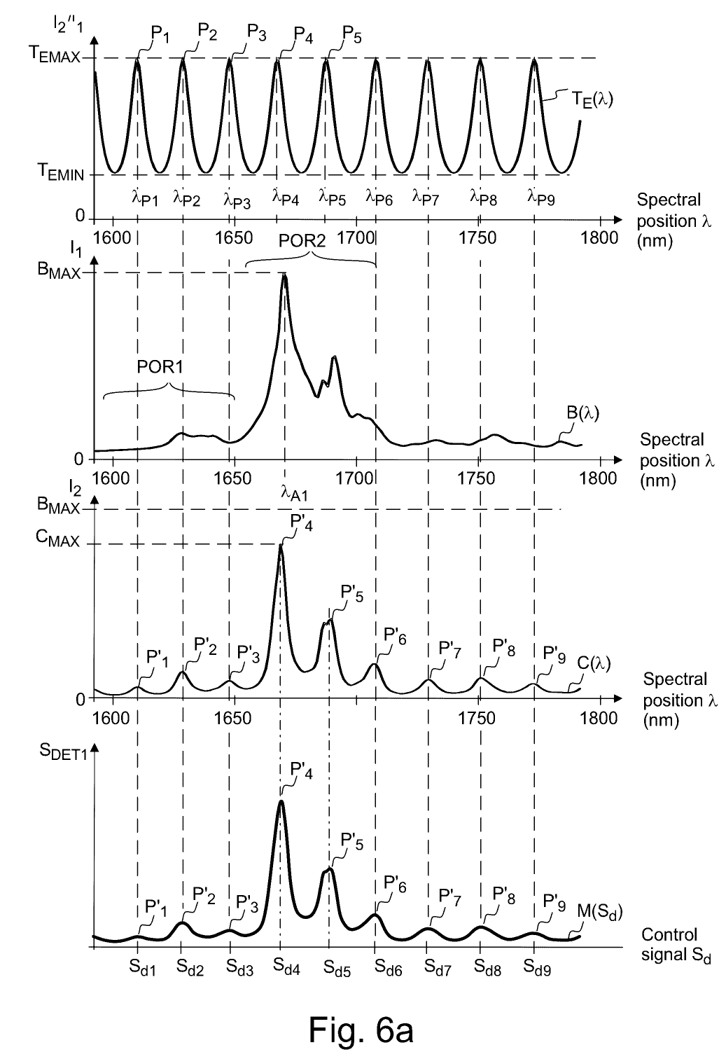

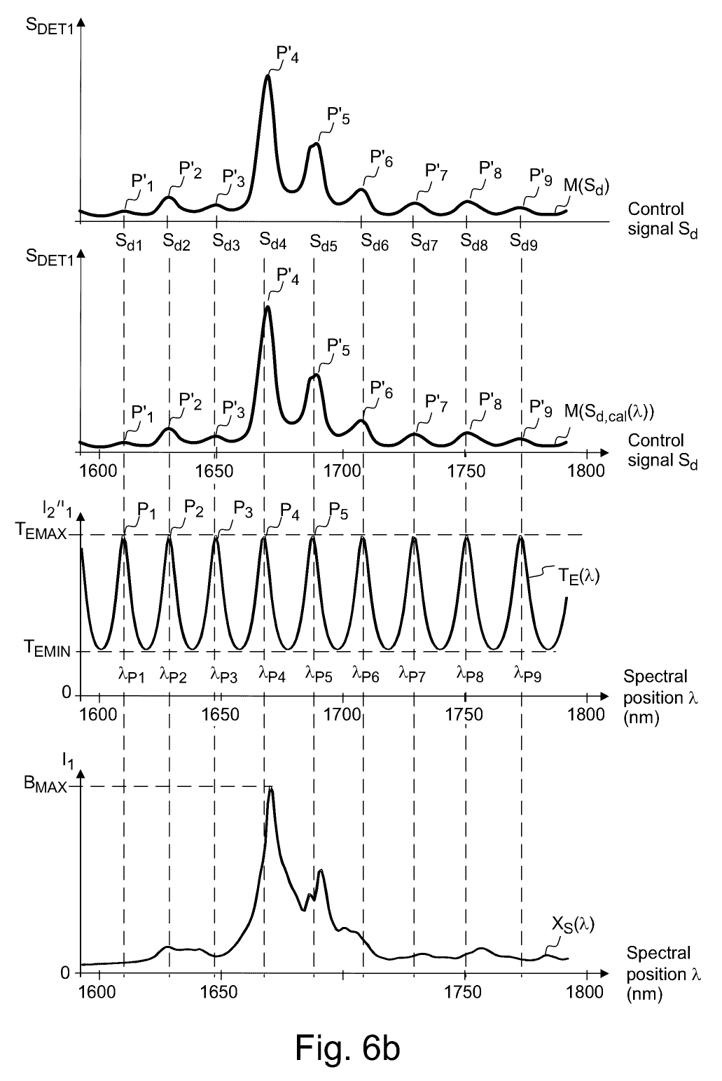

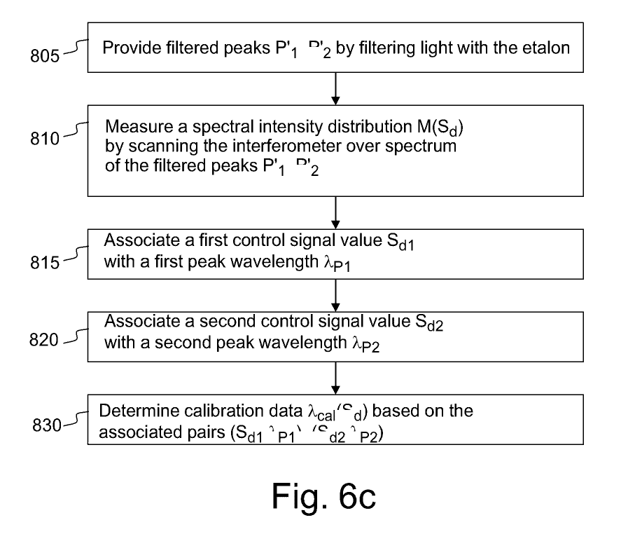

FIG. 6a illustrates the effect of the etalon 50 on the spectrum of light transmitted through the etalon 50. Input light LB1 impinging on the etalon 50 may have an input spectrum B(λ), and filtered light LB2 transmitted through the etalon 50 may have a filtered spectrum C(λ).The etalon 50 may provide the filtered light LB2 by filtering the input light LB1. The filtered spectrum C(λ) may be obtained by multiplying the input spectrum B(λ) with the transmittance T_{E}(λ) of the etalon 50:

C(λ)=T_{E}(λ)·B(λ) (1)

The uppermost curve of FIG. 6a shows the spectral transmittance T_{E}(λ) of the etalon 50. The transmittance T_{E}(λ) may have a plurality of peaks P1, P2, P3 at accurately known wavelengths λ_{P1}, λ_{P2}, λ_{P3}, . . .

The peaks P1, P2, P3, . . . may have, for example a maximum transmittance T_{EMAX}. Between adjacent peaks P1, P2, P3, . . . a minimum transmittance peak with an intensity ratio T_{EMIN} is located at accurately known wavelengths. According to certain embodiments, the minimum transmittance peaks and the maximum transmittance peaks of the etalon 50 can be used for determining spectral calibration data λ_{cal}(S_{d}), S_{d,cal}(λ) of a Fabry-Perot interferometer 100.

The second curve from the top of FIG. 6a shows an input spectrum B(λ) of input light LB1 received from an object OBJ1. The light LB1 may be e.g.

reflected from the object OBJ1, emitted by the object OBJ1, and/or transmitted through the object OBJ1. The input spectrum B(λ) may have one or more moderately sloped portions POR1. The moderately sloped portion POR1 means a portion where the absolute value of the derivative ∂B(λ)/∂λ is smaller than or equal to a predetermined limit at each spectral position of said portion, and where the spectrum B(λ) is greater than zero. The input spectrum B(λ) may also have one or more steeply sloped portions POR2. The steeply sloped portion POR2 means a portion where the absolute value of the derivative ∂B(λ)/∂λ is higher than said predetermined limit. The moderately sloped portion POR1 may also be called e.g. as a substantially flat portion. The steeply sloped portion POR2 may also be called e.g. as a steep portion.

The third curve from the top of FIG. 6a shows a filtered spectrum C(λ), which is formed by filtering the input spectrum B(λ) with the etalon 50. The filtered spectrum C(λ) may have a plurality of filtered peaks P′₁, P′₂, P′₃, . . . at spectral positions λP′₁, λP′₂, λP′₃, . . . A filtered peak P′₁ may be formed by multiplying the input spectrum B(λ) with the transmittance T_{E}(λ) in the vicinity of the wavelength λ_{P1}. Each individual filtered peak P′₁, P′₂, P′₃, . . . may be formed by filtering the input spectrum B(λ) with an individual transmission peak P₁, P₂, P₃, . . . The filtered spectrum may be expressed as a function C(λ) of spectral position λ.

The maximum value of an individual filtered peak P′₁ may be attained when the control signal S_{d} of the Fabry-Perot interferometer 100 is equal to a marker value S_{d1}. The marker value S_{d1} of the filtered peak P′₁ may be determined by scanning the Fabry-Perot interferometer 100 and by analyzing when the detector signal S_{DET1} attains a local maximum. The marker value S_{d1} of the filtered peak P′₁ may be determined by varying the control signal S_{d}, measuring the distribution M(S_{d}) as a function of the control signal S_{d}, and by determining a control signal value S_{d1} where the distribution M(S_{d}) attains a local maximum.

Referring to the lowermost curve of FIG. 6a, a spectral intensity distribution M(S_{d}) of the filtered light may be measured by scanning the Fabry-Perot interferometer 100. The measured spectral intensity distribution M(S_{d}) may be formed as a convolution of the filtered spectrum C(λ) with the transmittance T_{FP}(λ) of the Fabry-Perot interferometer 100. The measured spectral intensity distribution M(S_{d}) may be converted into a calibrated measured spectral intensity distribution M(S_{d,cal}(λ)) by using the spectral calibration data λ_{cal}(S_{d}) and/or S_{d,cal}(λ).

The filtered spectrum C(λ) may attain a local maximum value at a peak wavelength λ_{P1}. The filtered spectrum C(λ) may attain local maximum values at peak wavelengths λ_{P1}, λ_{P2}, λ_{P3}, . . . The measured spectral intensity distribution M(S_{d}) may attain a local maximum value when the control signal is equal to a marker value S_{d1}. The distribution M(S_{d}) may attain local maximum values at marker values S_{d1}, S_{d2}, S_{d3}, . . .

The calibration function λ_{cal}(S_{d}) and/or S_{d,cal}(λ) may be determined by matching the distribution M(S_{d}) with the transmittance function T_{E}(λ). The calibration function λ_{cal}(S_{d}) and/or S_{d,cal}(λ) may be determined by using matching marker values S_{d1}, S_{d2}, S_{d3}, . . . determined from the measured distribution M(S_{d}), and by using the accurately known wavelengths λ_{P1}, λ_{P2}, λp₃, . . . of the transmittance peaks P1, P2, P3.

The spectral position λP1 of the transmission peak P₁ is accurately known, and the spectral position P_{P′1} of a filtered peak P′₁ of the filtered spectrum C(λ) may substantially coincide with the spectral position λ_{P1} of a transmission peak P₁ of the etalon 50 when the transmission peak P₁ is within a moderately sloped portion POR1 of the spectrum B(λ). The calibration function λ_{cal}(S_{d}) ^{and/or S}_{d,cal}(λ) may be determined and/or checked based on the position of the filtered peak P′₁. In particular, the calibration function λ_{cal}(S_{d}) and/or S_{d,cal}(λ) may be determined and/or checked based on the marker signal value S_{d1} associated with the filtered peak P′₁.

On the other hand, the spectral position of a filtered peak P′₄ of the filtered spectrum C(λ) may substantially deviate from the spectral position λ_{P4} of a transmission peak P₄ of the etalon 50 when the transmission peak P₄ is within a steeply sloped portion POR2. One or more marker values S_{d4}, S_{d5} may be associated with filtered peaks P′4, P′5, which deviate from the spectral positions λ₄, λ₅ of the corresponding transmission peaks P4, P5, because the spectral positions λ₄, λ₅ are within a steeply sloped portion POR2 of the input spectrum B(λ). One or more non-matching marker values S_{d4}, S_{d5} may be omitted when determining and/or checking the calibration function λ_{cal}(S_{d}) and/or S_{d,cal}(λ).

The distribution M(S_{d}) may comprise a plurality of filtered peaks P′₁, P′₂, P′₃, . . . . The shape of each filtered peak P′₁, P′₂, P′₃, . . . may be compared with the shape of a transmittance peak P1, P2, P3 of the transmittance T_{E}(λ) in order to determine whether the marker value S_{d1} of the filtered peak P′₁ can be used for checking the spectral calibration. The shape of a filtered peak may correspond to the shape of a transmittance peak if the input spectrum is a slowly varying function of the wavelength.

The method may comprise determining whether a marker value S_{d1} corresponds to a peak wavelength λp₁, which is within a moderately sloped portion POR1 of the input spectrum B(λ).Said determining may be performed e.g. by determining an estimate B_{M}(λ) of the input spectrum B(λ), and checking whether the absolute value of the derivative ∂B_{M}(λ)/∂λis smaller than or equal to a predetermined limit in the vicinity of a spectral position λ₁. A peak wavelength λ_{P1} may be within a moderately sloped portion POR1 of the input spectrum B(λ) if the absolute value of the derivative ∂B_{M}(λ)/∂λis smaller than or equal to a predetermined limit b1 in the vicinity of the peak wavelength λ_{P1}.

Said estimate B_{M}(λ) of the input spectrum B(λ) may be calculated e.g. by providing a calibrated distribution M(S_{cal,d}(λ)) from the measured distribution M(S_{d}), and by dividing the calibrated distribution M(S_{cal,d}(λ)) with the transmittance T_{E}(λ) of the etalon 50:

$${B}_{M} ( λ ) = {k}_{int} \cdot \frac{M ( {S}_{cal , d} ( λ ) )}{{T}_{E} ( λ )} \qquad ( 2 )$$

kᵢₙₜ denotes an intensity calibration coefficient. kᵢₙₜ may also depend on the wavelength. The intensity calibration data CPAR1 may comprise the calibration coefficient kᵢₙₜ.

A control signal value S_{d}(λ_{P1}) corresponding to the peak wavelength λ_{P1} may be estimated by using the calibration function S_{cal,d}(λ), or by using a preliminary calibration function S_{cal,d}(λ).

S_{d}(λ_{P1})≈S_{cal,d}(λ_{P1}) (3)

The estimated control signal value S_{cal,d}(λ_{P1}) may be compared with the marker values S_{d1}, S_{d2}, S_{d3}, . . . in order to determine whether the estimated control signal value S_{cal,d}(λ_{P1}) substantially coincides with any of the marker values S_{d1}, S_{d2}, S_{d3}, . . . The estimated control signal value S_{cal,d}(λ_{P1}) may substantially coincide with a marker value S_{d1} e.g. when the difference between the marker value S_{d1} and the estimated control signal value S_{cal,d}(λ_{P1}) is smaller than or equal to a predetermined limit value ΔS_{LIM}.

|S_{d1}−S_{cal,d}(λ_{d1})|ΔS_{LIM} (4)

Each marker value S_{d1}, S_{d2}, S_{d3}, S_{d4}, . . . may be classified to be a matching value or a non-matching value. A marker value S_{d1} may be classified to be a matching value if the marker value S_{d1} corresponds to a peak wavelength λ_{P1}, which is within a moderately sloped portion POR1 of the input spectrum B(λ), and if the marker value S_{d1} substantially coincides with an estimated control signal value S_{cal,d}(λ_{P1}). A marker value S_{d4} may be classified to be a non-matching value if the marker value S_{d4} corresponds to a peak wavelength λ_{P4}, which is within a steeply sloped portion POR2 of the input spectrum B(λ), and/or if the marker value S_{d4} substantially deviates from all estimated control signal values S_{cal,d}(λ_{P1}), S_{cal,d}(λ_{P2}), S_{cal,d}(λ_{P3}), S_{cal,d}(λ_{P4}), . . . The matching marker values S_{d1}, S_{d2}, S_{d3}, . . . may be used for checking and/or improving the accuracy of the calibration function S_{cal,d}(λ).

Data pairs (λ_{P1}, S_{d1}), (λ_{P2}, S_{d2}), (λ_{P3}, S_{d3}), . . . for determining and/or checking the calibration function λ_{cal}(S_{d}) and/or S_{d,cal}(λ) may be obtained by:
determining a plurality of marker values S_{d1}, S_{d2}, S_{d3}, . . . from the measured distribution M(S_{d}),
classifying two or more marker values S_{d1}, S_{d2}, S_{d3}, . . . as matching marker values S_{d1}, S_{d2}, S_{d3}, . . . , and
forming the data pairs (λ_{P1}, S_{d1}), (λ_{P2}, S_{d2}), (λ_{P3}, S_{d3}) by associating each matching marker value S_{d1}, S_{d2}, S_{d3}, . . . with an accurately known peak wavelength λ_{P1}, λ_{P2}, λ_{P3}, . . . of a transmittance peak P1, P2, P3.

The accuracy of a calibration function λ_{cal}(S_{d}) and/or S_{d,cal}(λ) may be improved and/or checked by using the data pairs (λ_{P1}, S_{d1}), (λ_{P2}, S_{d2}), (λ_{P3}, S_{d3}). A modified calibration function λ_{cal}(S_{d}) and/or S_{d,cal}(λ) may be determined by using the data pairs (λ_{P1}, S_{d1}), (λ_{P2}, S_{d2}), (λ_{P3}, S_{d3}). The modified calibration function λ_{cal}(S_{d}) and/or S_{d,cal}(λ) may be slightly different from the preliminary calibration function. The modified calibration function λ_{cal}(S_{d}) and/or S_{d,cal}(λ) may be stored e.g. in a memory MEM3.

An improved estimate B_{M}(λ) for input spectrum B(λ) may subsequently be determined by providing a calibrated distribution M(S_{cal,d}(λ)) from the measured distribution M(S_{d}) by using the modified calibration function S_{cal,d}(λ), and by dividing the calibrated distribution M(S_{cal,d}(λ)) with the transmittance T_{E}(λ) of the etalon 50:

$${B}_{M} ( λ ) = {k}_{int} \cdot \frac{M ( {S}_{cal , d} ( λ ) )}{{T}_{E} ( λ )} \qquad ( 5 )$$

The filtered spectrum C(λ) of FIG. 6a may represent the spectrum of light transmitted through the etalon 50. The filtered spectrum C(λ) may represent the spectrum of light transmitted through the etalon 50 in a situation where the etalon is positioned optically before the Fabry-Perot interferometer 100. However, the calibration function λ_{cal}(S_{d}) and/or S_{d,cal}(λ) may be determined and/or checked by using the data pairs (λ_{P1}, S_{d1}), (λ_{P2}, S_{d2}), (λ_{P3}, S_{d3}) also when the etalon 50 is positioned optically after the interferometer 100.

The distribution M(S_{d}) is measured by scanning the interferometer 100. Different peaks of the spectrum may be scanned at different times. The distribution M(S_{d}) may represent a time-averaged spectrum of the filtered peaks provided by the etalon 50. The distribution M(S_{d}) does not need to represent an instantaneous spectrum of light transmitted through the etalon 50. Increasing the finesse of the etalon 50 may reduce the minimum spectral transmittance T_{E,MIN} of the etalon 50. If the minimum spectral transmittance T_{E,MIN} is very low, this may reduce accuracy of the intensity values and/or may cause loss of spectral data. The reflectance of the coatings of the etalon 50 may be selected such that the minimum spectral transmittance T_{E,MIN} of the etalon 50 e.g. lower than or equal to 90% of the maximum spectral transmittance T_{E,MAX} of the etalon 50. The reflectance of the coatings of the etalon 50 may be selected such that the minimum spectral transmittance T_{E,MIN} of the etalon 50 e.g. is in the range of 10% to 90% of the maximum spectral transmittance T_{E,MAX} of the etalon 50.

In an embodiment, a first part of the input light LB1 may be coupled to the interferometer via the etalon 50, and a second part of the input light may be simultaneously coupled to the interferometer 100 without passing through the etalon. For example, the etalon 50 may cover less than 100% of the cross-section of the aperture of the interferometer 100. For example, the input light LB1 may be divided into a first part and a second part by using a beam splitter, wherein the first part may be coupled to the interferometer 100 through the etalon 50, and the second part may be coupled to the interferometer 100 without passing through the etalon 50. The spectrometer 500 may comprise e.g. optical fibers, prisms and/or mirrors for guiding the first part and/or the second part. Consequently, the spectrum C(λ) may have narrow well-defined filtered peaks P′₁, P′₂, P′₃, . . . without causing significant loss of data between the peaks of the spectrum C(λ). Consequently, the spectrum C(λ) may have narrow well-defined filtered peaks P′₁, P′₂, P′₃, . . . without causing significant reduction of accuracy of the intensity values between the peaks of the spectrum C(λ).

In an embodiment, the minimum spectral transmittance T_{E,MIN} of the etalon 50 may be very low when spectral information is not needed from the spectral regions between the adjacent transmittance peaks P1, P2, P3, . . . The minimum spectral transmittance T_{E,MIN} may be e.g. lower than 10% of the maximum spectral transmittance T_{E,MAX}. The minimum spectral transmittance T_{E,MIN} may be e.g. lower than 1% of the maximum spectral transmittance T_{E,MAX}.

The calibration function λ_{cal}(S_{d}) and/or S_{d,cal}(λ) may be determined by matching the measured distribution M(S_{d}) with the transmittance function T_{E}(λ), wherein the matching may comprise using cross-correlation. The measured distribution M(S_{d}) may be compared with the spectral transmittance (T_{E}(λ)) of the etalon (50) by using cross-correlation analysis. The calibration function λ_{cal}(S_{d}) and/or S_{d,cal}(λ) may be determined by correlation analysis. The distribution M(S_{d}) may indicate intensity values as the function of control signal S_{d}. A calibrated distribution M(S_{d,cal}(λ)) may be determined from the measured distribution M(S_{d}) by using the calibration function S_{d,cal}(λ). The calibrated distribution M(S_{d,cal}(λ)) may provide intensity values as the function of spectral position λ. The calibration function S_{d,cal}(λ) may be a regression function, which has one or more adjustable parameters. For example, the calibration function S_{d,cal}(λ) may be a polynomial function, and the adjustable parameters may be the coefficients of the terms of the polynomial function.

The cross-correlation of the calibrated distribution M(S_{d,cal}(λ)) with the transmittance function T_{E}(λ) may provide a value, which indicates the degree of similarity between the calibrated distribution M(S_{d,cal}(λ))and the transmittance function T_{E}(λ). The calibration function λ_{cal}(S_{d}) and/or S_{d,cal}(λ) may be determined by adjusting one or more parameters of the regression function S_{d,cal}(λ), and calculating the cross-correlation of the calibrated distribution M(S_{d,cal}(λ)) with the transmittance function T_{E}(λ). One or more parameters of the regression function may be adjusted until the cross-correlation of the calibrated distribution M(S_{d,cal}(λ)) with the transmittance function T_{E}(λ) reaches a maximum value. The cross-correlation may reach a maximum value when the spectral positions of the peaks of the calibrated distribution M(S_{d,cal}(λ)) substantially coincide with the spectral positions of the peaks of the transmittance function T_{E}(λ).

An auxiliary transmittance function T_{E}(λ_{cal}(S_{d})) of the etalon 50 may give the transmittance of the etalon 50 as the function of control signal S_{d}. The calibration function λ_{cal}(S_{d}) may be expressed as a regression function, which has one or more adjustable parameters. One or more parameters of the regression function may be adjusted until the cross-correlation of the measured distribution M(S_{d}) with the auxiliary transmittance function T_{E}(λ_{cal}(S_{d})) reaches a maximum value.

The method may comprise:
providing a regression function S_{d,cal}(λ) or (λ_{cal}(S_{d}),
determining a calibrated spectral intensity distribution (M(S_{d,cal}(λ)) from the measured spectral intensity distribution (M(S_{d})) by using the regression function, and
determining one or more parameters of the regression function (S_{d,cal}(λ)) such that the cross-correlation of the calibrated spectral intensity distribution (M(S_{d,cal}(λ)) with the spectral transmittance (T_{E,MAX}) of the etalon (50) reaches a maximum value.

The method may comprise:
providing a regression function S_{d,cal}(λ) or (λ_{cal}(S_{d}),
determining an auxiliary transmittance (T_{E}(λ_{cal}(S_{d})) from the spectral transmittance (T_{E}(λ)) of the etalon (50) by using the regression function, and
determining one or more parameters of the regression function (λ_{cal}(S_{d})) such that the cross-correlation of the distribution (M(S_{d})) with the auxiliary transmittance (T_{E}(λ_{cal}(S_{d})) reaches a maximum value.

In an embodiment, the accuracy of the calibration function λ_{cal}(S_{d}) and/or S_{d,cal}(λ) may be verified by checking whether the maximum value of the cross-correlation is higher than or equal to a predetermined limit. If the maximum value of the cross-correlation is lower than the predetermined limit, this may be an indication that the calibration function is not valid.

The spectrometer 500 may comprise a temperature sensor 58 for monitoring operating temperature of the etalon 50 (see e.g. FIG. 5). The temperature sensor 58 may provide a temperature signal S_{TEMP} indicative of the operating temperature of the etalon 50. The temperature sensor 58 may provide a temperature signal S_{TEMP} indicative of the operating temperature of the substrate of the etalon 50. The sensor may be implemented e.g. by a thermocouple, Pt100 sensor, or by a P-N junction. The spectral positions of the transmittance peaks of the etalon may be accurately known as a function of the operating temperature. The method may comprise monitoring the temperature of the etalon 50, and determining a spectral position λ_{P1} of a transmittance peak P1 based on the temperature of the etalon 50. Accordingly, an apparatus comprises means for providing a temperature signal S_{TEMP} indicative of the operating temperature of the etalon 50 and means for determining a spectral position λ_{P1} of the first transmittance peak P1 based on the temperature of the etalon 50 according to certain embodiments.

According to certain embodiments, variation of performance characteristics due to temperature changes can be considered by means of the temperature signal S_{TEMP} indicative of the operating temperature of the substrate of the etalon 50, thus improving precision of calibration. The spectral positions of the transmittance peaks of the etalon 50 as a function of the operating temperature may be, for example, calculated by the control unit CNT1.

As changes of temperatures of the environment typically also affect the operating temperature of the Fabry-Perot interferometer 100, temperature drift will occur in the wavelength response of the interferometer 100. Suprisingly, the temperature signal S_{TEMP} indicative of the operating temperature of the substrate of the etalon 50 can also be used for calculation of temperature related performance characteristics of the Fabry-Perot interferometer 100 according to certain embodiments. Further, the temperature signal S_{TEMP} indicative of the operating temperature of the substrate of the etalon 50 can be used for calculation of temperature related performance characteristics of any given unit of the system according to certain embodiments.

FIG. 6b shows determining a calibrated spectrum λ_{S}(λ) from the measured spectral intensity distribution M(S_{d}) of FIG. 6a. The uppermost curve of FIG. 6b shows the measured spectral intensity distribution M(S_{d}), which may be obtained by varying the mirror gap d_{FP}, and by recording the detector signal values S_{DET1} as the function of the control signal S_{d}. The second curve from the top of FIG. 6b shows a calibrated spectral intensity distribution M(S_{d,cal}(λ)) determined from the distribution M(S_{d}) by using the calibration function λ_{cal}(S_{d}) and/or S_{d,cal}(λ). The calibrated measured spectrum λ_{S}(λ) may be determined from the distribution M(S_{d,cal}(λ)) by using the spectral transmittance T_{E}(λ) of the etalon and by using the intensity calibration data CPAR1. Calibrated intensity values may be determined from the detector signal values S_{DET1} by using the intensity calibration data CPAR1. The filtering effect of the etalon may be compensated by dividing the calibrated spectral intensity distribution M(S_{d,cal}(λ)) with the spectral transmittance T_{E}(λ). The filtering effect of the etalon may be compensated by multiplying with the function T_{E}(λ). The calibrated measured spectrum λ_{S}(λ) may be obtained by multiplying the calibrated spectral intensity distribution M(S_{d,cal}(λ)) with the function 1/T_{E}(λ), and by using the intensity calibration data CPAR1 to convert detector signal values to calibrated intensity values. The calibrated measured spectrum λ_{S}(λ) may represent the spectrum B(λ) of the input light LB1. The calibrated measured spectrum λ_{S}(λ) of the input light LB1 may represent the spectrum of the object OBJ1.

FIG. 6c shows, by way of example, method steps for matching the measured distribution with the spectral transmittance of the etalon. The matching may comprise associating control signal values with predetermined spectral positions.

In step 805, a plurality of filtered peaks P′₁, P′₂ may be provided by filtering input light LB1 with the etalon 50.

In step 810, the distribution M(S_{d}) may be measured by scanning the interferometer 100 over the filtered peaks P′₁, P′₂.

In step 815, a first marker signal value S_{d1} may be determined by analyzing a first peak P′₁ of the distribution M(S_{d}). The first marker signal value S_{d1} may be associated with the spectral position λ_{P1} of the first peak P1 of the spectral transmittance T_{E}(λ) of the etalon 50.

In step 820, a second marker signal value S_{d2} may be determined by analyzing a second peak P′₂ of the distribution M(S_{d}). The second marker signal value S_{d2} may be associated with the spectral position λ_{P2} of the second peak P2 of the spectral transmittance T_{E}(λ) of the etalon 50.

In step 830, the calibration data λ_{cal}(S_{d}) ^{and/or S}_{d,cal}(λ) may be determined from the associated pairs (λ_{P1}, S_{d1}), (λ_{P2}, S_{d2}).

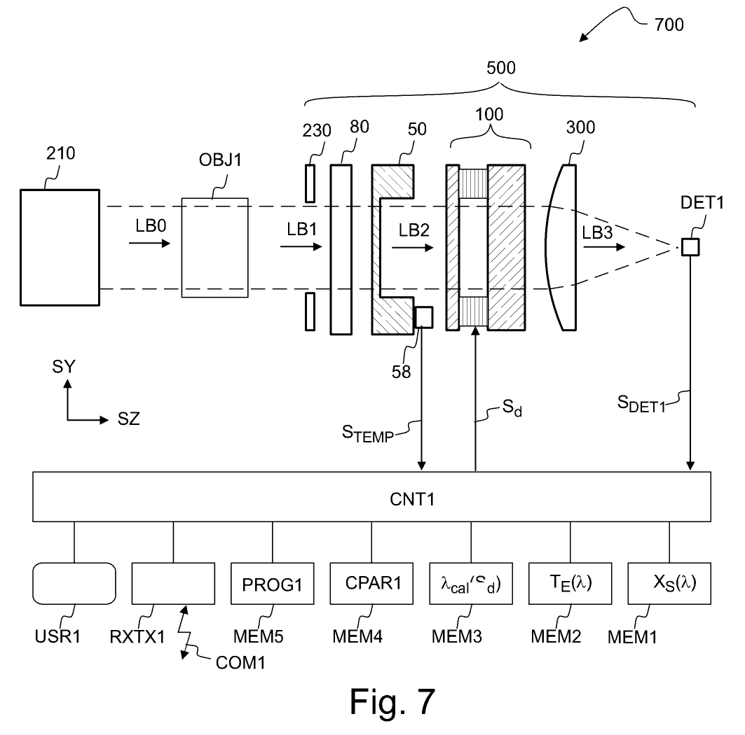

FIG. 7 shows an apparatus 700 suitable for absorption or reflection measurements. The apparatus 700 may comprise a spectrometer 500 and a light source unit 210. The light source unit 210 may provide illuminating light LB0. The apparatus 700 may be arranged to analyze an object OBJ1. The object OBJ1 may be e.g. an amount of chemical substance contained in a cuvette. The object OBJ1 may be e.g. a piece of material. The light source unit 210 may be arranged to illuminate the object OBJ1. The spectrometer 500 may be arranged to receive light LB1 transmitted through the object OBJ1 and/or to receive light LB1 reflected from the object OBJ1.

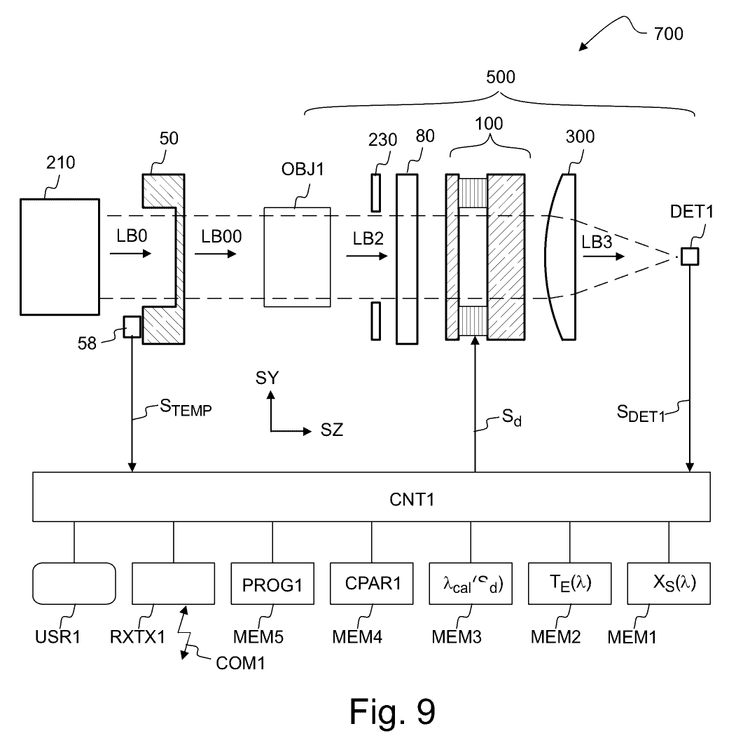

The apparatus 700 may comprise an etalon 50. The etalon may be arranged to filter light transmitted via the optical path of the apparatus 700. For example, the etalon 50 may be positioned between the object OBJ1 and the spectrometer 500. For example, the light source unit 210 may comprise the etalon 50. For example, the spectrometer 500 may comprise the etalon 50. For example, the etalon may be positioned between the light source unit 210 and the object OBJ1 (see FIG. 9).

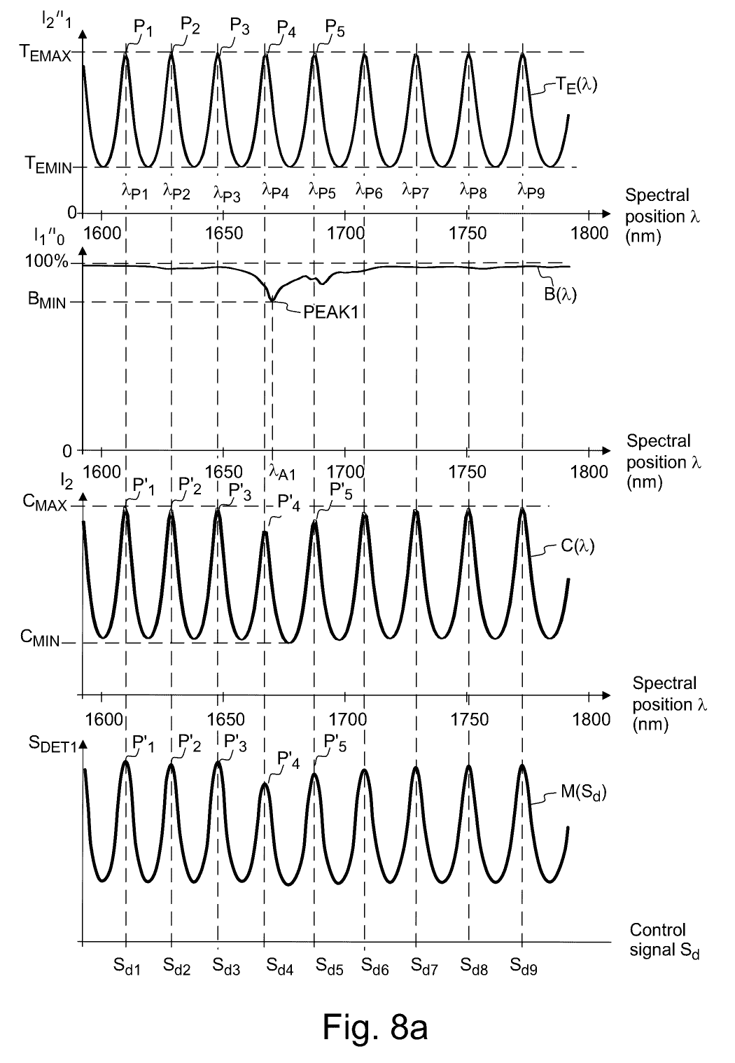

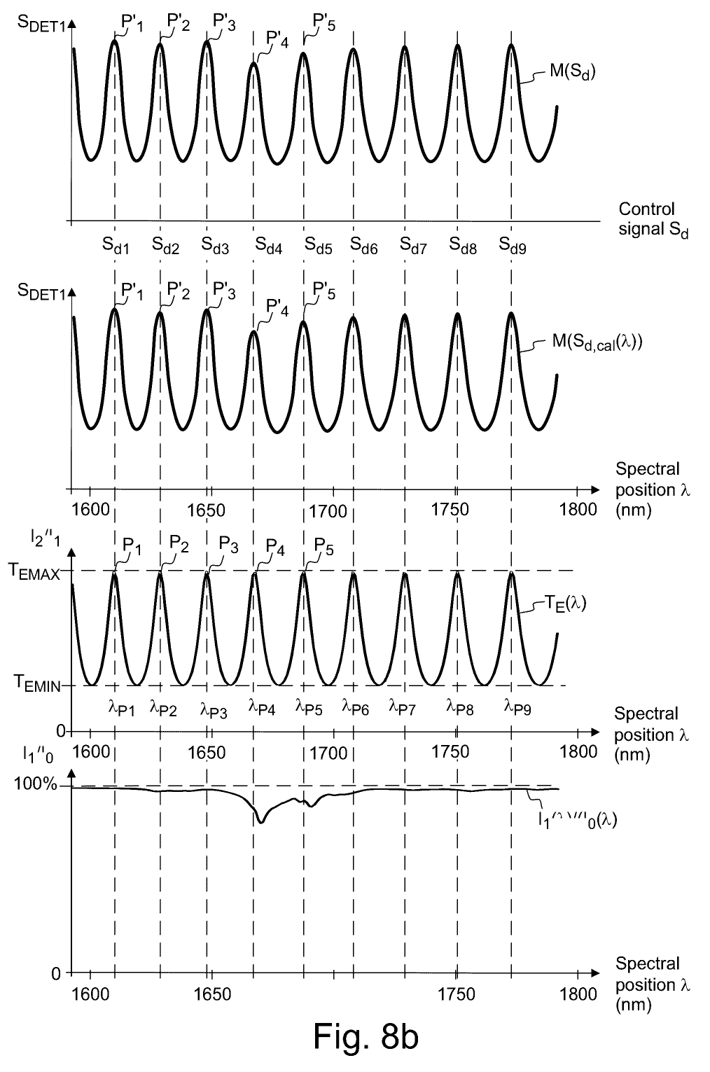

FIG. 8a illustrates filtering of light by the etalon 50 in case of the absorption (or reflectance) measurement. Input light LB1 impinging on the etalon 50 may have an input spectrum B(λ), and filtered light LB2 transmitted through the etalon 50 may have a filtered spectrum C(λ).The etalon 50 may provide the filtered light LB2 by filtering the input light LB1. The filtered spectrum C(λ) may be obtained by multiplying the input spectrum B(λ) with the transmittance T_{E}(λ) of the etalon 50 (see equation 1).

The uppermost curve of FIG. 8a shows the spectral transmittance T_{E}(λ) of the etalon 50. The second curve from the top of FIG. 8a shows an input spectrum B(λ). The input spectrum B(λ) may be e.g. an absorption spectrum or a reflectance spectrum. The third curve from the top of FIG. 8a shows a filtered spectrum C(λ), which is formed by filtering the input spectrum B(λ) with the etalon 50. The lowermost curve of FIG. 8a shows a measured spectral intensity distribution M(S_{d}) obtained by scanning the interferometer 100 over the filtered peaks P′₁, P′₂ of the spectrum C(λ).

The spectral intensity distribution M(S_{d}) of the filtered light may be measured by scanning the Fabry-Perot interferometer 100. The measured distribution M(S_{d}) may be converted into a calibrated distribution by using the calibration function λ_{cal}(S_{d}) and/or S_{d,cal}(λ). The calibration function λ_{cal}(S_{d}) and/or S_{d,cal}(λ) may checked by comparing the measured distribution M(S_{d}) with the spectral transmittance T_{E}(λ) of the etalon 50

The spectral position λ_{P1} of the transmission peak P₁ is accurately known, and the spectral position of a filtered peak P′₁ of the filtered spectrum C(λ) may substantially coincide with the spectral position λ_{P1} of a transmission peak P₁ of the etalon 50 when the transmission peak P₁ is within a moderately sloped portion POR1 of the spectrum B(λ). Each marker value S_{d1}, S_{d2}, S_{d3}, S_{d4}, . . . may be classified to be a matching value or a non-matching value. A marker value S_{d1} may be classified to be a matching value if the marker value S_{d1} corresponds to a peak wavelength λ_{P1}, which is within a moderately sloped portion POR1 of the input spectrum B(λ), and if the marker value S_{d1} substantially coincides with an estimated control signal value S_{cal,d}(λ_{P1}). One or more spectral positions, e.g. the position λ₄ may be within a steeply sloped portion POR2 of the input spectrum B(λ). One or more marker values S_{d4} may be omitted when determining and/or checking the calibration function λ_{cal}(S_{d}) and/or S_{d,cal}(λ).

Data pairs (λ_{P1}, S_{d1}), (λ_{P2}, S_{d2}), (λ_{P3}, S_{d3}), . . . for determining and/or checking the calibration function λ_{cal}(S_{d}) and/or S_{d,cal}(λ) may be obtained by:
determining a plurality of marker values S_{d1}, S_{d2}, S_{d3}, . . . from a measured distribution M(S_{d}),
classifying two or more marker values S_{d1}, S_{d2}, S_{d3}, . . . as matching marker values S_{d1}, S_{d2}, S_{d3}, and
forming the data pairs (λ_{P1}, S_{d1}), (λ_{P2}, S_{d2}), (λ_{P3}, S_{d3}) by associating each matching marker value S_{d1}, S_{d2}, S_{d3}, . . . with an accurately known peak wavelength λ_{P1}, λ_{P2}, λ_{P3}, . . . of a transmittance peak P1, P2, P3.

The accuracy of a calibration function λ_{cal}(S_{d}) and/or S_{d,cal}(λ) may be improved and/or checked by using the data pairs (λ_{P1}, S_{d1}), (λ_{P2}, S_{d2}), (λ_{P3}, S_{d3}). A modified calibration function λ_{cal}(S_{d}) ^{and/or S}_{d,cal}(λ) may be determined by using the data pairs (λ_{P1}, S_{d1}), (λ_{P2}, S_{d2}), (λ_{P3}, S_{d3}). The modified calibration function λ_{cal}(S_{d}) and/or S_{d,cal}(λ) may be slightly different from the preliminary calibration function. The modified calibration function λ_{cal}(S_{d}) and/or S_{d,cal}(λ) may be stored e.g. in a memory MEM3.

An improved estimate B_{M}(λ) for input spectrum B(λ) may subsequently be determined by providing a calibrated distribution M(S_{cal,d}(λ)) from the measured distribution M(S_{d}) by using the modified calibration function S_{cal,d}(λ), and by dividing the calibrated distribution M(S_{cal,d}(λ)) with the transmittance T_{E}(λ) of the etalon 50 (see equation 5).

FIG. 8b shows forming a measured absorption spectrum I₁(λ)/I₀(λ) from the measured spectral intensity distribution M(S_{d}) of FIG. 8a. The uppermost curve of FIG. 8b shows the measured spectral intensity distribution M(S_{d}), which may be obtained by varying the mirror gap d_{FP}, and by recording the detector signal values S_{DET1} as the function of the control signal S_{d}. The second curve from the top of FIG. 8b shows a calibrated spectral intensity distribution M(S_{d,cal}(λ)) determined from the measured spectral intensity distribution M(S_{d}) by using the calibration function λ_{cal}(S_{d}) and/or S_{d,cal}(λ).The filtering effect of the etalon may be compensated by dividing the calibrated spectral intensity distribution M(S_{d,cal}(λ)) with the spectral transmittance T_{E}(λ). The filtering effect of the etalon may be compensated by multiplying with the function 1/T_{E}(λ).

If desired, a calibrated measured spectrum X_{S}(λ) may be obtained by multiplying the calibrated spectral intensity distribution M(S_{d,cal}(λ)) with the function 1/T_{E}(λ), and by using the intensity calibration data CPAR1 to convert detector signal values to calibrated intensity values. The calibrated measured spectrum X_{S}(λ) may represent the spectrum of light transmitted through the object OBJ1 or the spectrum of light reflected by the object OBJ1.

The absorption spectrum I₁(λ)/I₀(λ) may also be determined by using a reference distribution. In an embodiment, the absorption spectrum I₁(λ)/I₀(λ) may be determined without determining calibrated intensity values. The reference distribution M_{REF}(S_{d,cal}(λ)) may be obtained by measuring the spectral intensity distribution without the absorbing sample OBJ1. The reference distribution M_{REF}(S_{d,cal}(λ)) may represent e.g. the spectrum of the illuminating light LB0. The reference distribution M_{REF}(S_{d,cal}(λ)) may be stored e.g. in the memory MEM4 of the apparatus 700. The measured absorption spectrum I₁(λ)/I₀(λ) may be determined from the calibrated spectral intensity distribution M(S_{d,cal}(λ)) by using the spectral transmittance T_{E}(λ) of the etalon, and by using the reference distribution M_{REF}(S_{d,cal}(λ)). A compensated spectral intensity distribution may be determined from the calibrated spectral intensity distribution M(S_{d,cal}(λ)) by dividing with the spectral transmittance 1/T_{E}(λ), and the measured absorption spectrum I₁(λ)/I₀(λ) may be determined by dividing the reference distribution M_{REF}(S_{d,cal}(λ)) with the compensated spectral intensity distribution M(S_{d,cal}(λ))/T_{E}(λ).

Referring to FIG. 9, the etalon 50 may also be positioned between the light source unit 210 and the object OBJ1.

When measuring the reflectance spectrum of an object OBJ1, the object OBJ1 may be illuminated with illuminating light. The illuminating light may have a broad spectrum. In an embodiment, the bandwidth of the illuminating light may be greater than or equal to the detection range of the spectrometer 500.

FIG. 10 shows, by way of example, an interferometer 100 where the optical cavity has been formed by etching. The spectrometer 500 may comprise the interferometer shown in FIG. 10. The spectrometer 500 may comprise an interferometer 100 where the optical cavity has been formed by etching. The spectrometer 500 may comprise an interferometer 100 where an empty space ESPACE1 between the mirrors 110, 120 has been formed by etching, after the material layers of the mirrors 110, 120 have been formed.

The mirror 110 may be supported by a spacer 115. The spacer 115 may be deposited on top of the mirror 120. The interferometer 100 may be produced by a method, which comprises depositing two or more material layers of the mirror 110 on top of the spacer 115. The empty space ESPACE1 between the mirrors 110, 120 may be formed by etching material away from between the mirrors 110, 120 after the two or more material layers of the mirror 110 have been deposited.

The first mirror 110 may have a movable portion MPOR1, and the first mirror 110 may be called e.g. as the movable mirror. The movable portion MPOR1 of the movable mirror 110 may be moved with respect to the stationary mirror 120 in order to adjust the mirror gap d_{FP}. The second mirror 120 may be called e.g. as the stationary mirror.

The stationary mirror 120 may comprise a plurality of material layers supported by substrate 130. The movable mirror 110 may be supported by the spacer layer 115. The spacer layer 115 may be formed on top of the stationary mirror 120, and the movable mirror 110 may be supported by the spacer layer 115. The movable mirror 110 may comprise e.g. material layers 110a, 110b, 110c, 110d, and/or 110e. The stationary mirror 120 may comprise e.g. material layers 120a, 120b, 120c, 120d, and/or 120e. The mirrors 110, 120 may be implemented by using reflective multilayer coatings. The mirrors 110, 120 may comprise reflective multilayer coatings. The material layers of the stationary mirror 120 may be formed e.g. by depositing material on top of a substrate 130 and/or by locally converting material of the substrate 130. The spacer layer 115 may be deposited on top of the stationary mirror 120 after the material layers of the stationary mirror 120 have been formed. The material layers of the movable portion MPOR1 may be formed after the spacer layer 115 has been deposited, by depositing material layers of the movable mirror 110 on top of the spacer layer 115. The material layers of the mirrors 110, 120 may be e.g. silicon-rich silicon nitride, polycrystalline silicon, doped polycrystalline silicon, silicon oxide and/or aluminum oxide. The layers may be deposited e.g. by using a LPCVD process. LPCVD means low pressure chemical vapor deposition. The substrate 130 may be e.g. monocrystalline silicon or fused silica. The spacer layer 115 may comprise e.g. silicon dioxide. The spacer layer 115 may consist essentially of silicon dioxide. The spacer layer 115 may consist of silicon dioxide. The empty space ESPACE1 between the mirrors 110, 120 of the interferometer 100 may be formed by etching. The material of the spacer layer 115 may etched away e.g. by using hydrofluoric acid (HF). The mirror 110 may comprise a plurality of miniature holes H1 for guiding hydrofluoric acid (HF) into the space between the mirrors 110, 120 and for removing the material of the spacer layer 115. The width of the holes H1 may be so small that they do not significantly degrade the optical properties of the interferometer 100.

The movable portion MPOR1 may be moved e.g. by an electrostatic actuator 140. The electrostatic actuator 140 may comprise two or more electrodes Ga, Gb. Vₐ denotes the voltage of the first electrode Ga, and V_{b} denotes the voltage of the second electrode Gb. The electrodes Ga, Gb may generate an attractive electrostatic force F1 when a voltage difference Vₐ-V_{b} (=V_{ab}) is applied between the electrodes Ga, Gb. The electrostatic force F1 may pull the movable portion MPOR1 towards the stationary mirror 120.

The electrostatic actuator 140 may be rugged, and/or mechanically stable and/or shock-proof. The electrostatic actuator 140 may have small size. The interferometer 100 may be produced at low costs when the interferometer 100 comprises the electrostatic actuator 140.

The interferometer 100 may optionally comprise a capacitive sensor for monitoring the mirror gap. The interferometer 100 may comprise an electrostatic actuator 140, and a capacitive sensor for monitoring the mirror gap. However, the use of the capacitive sensor is not necessary. Thanks to using the etalon for spectral stabilization, an interferometer 100 having an electrostatic actuator 140 may be implemented without a capacitive sensor for monitoring the mirror gap.

The voltage Vₐ may applied to the electrode Ga by using a conductor CON1 and a terminal N1. The voltage V_{b} may applied to the electrode Gb by using a conductor CON2 and a terminal N2. The voltages Vₐ, V_{b} may be provided by a voltage supply, which may be controlled by the control unit CNT1. The voltages Vₐ, V_{b} may be provided according to the control signal S_{d}. The terminals N1, N2 may be e.g. metallic, and the conductors CON1, CON2 may be e.g. bonded to the terminals N1, N2.

The aperture portion AP1 of the movable portion MPOR1 may have a width w1. The aperture portion AP1 of the movable mirror 110 may be substantially flat in order to provide sufficient spectral resolution. The magnitude of electrostatic forces directly exerted on the aperture portion AP1 may be kept low in order to preserve the flatness of the aperture portion AP1. An electrostatic force F1 for moving the movable portion MPOR1 may be generated by using a substantially annular electrode Gb, which surrounds the aperture portion AP2 of the stationary mirror 120. The mirror 120 may optionally comprise a neutralizing electrode Gc, which may be arranged to keep the aperture portion AP1 flat during the scanning, by reducing forces exerted on the aperture portion AP1. The neutralizing electrode Gc may be substantially opposite the aperture portion AP1 of the movable mirror 110. The voltage of the neutralizing electrode Gc may be kept substantially equal to the voltage Va of the electrode Ga, in order to reduce deformation of the aperture portion AP1 of the movable mirror 110. The voltage difference between the electrodes Ga and Gc may be kept smaller than a predetermined limit in order to reduce deformation of the aperture portion AP1 of the movable mirror 110. Consequently, the movable portion MPOR1 may be moved by the electrostatic force F1 such that said force F1 pulls an annular region surrounding the aperture portion AP1, wherein the aperture portion AP1 may remain as a substantially force-free region.

The neutralizing electrode Gc may be galvanically connected to the electrode Ga e.g. by using a connecting portion N1b. The annular electrode Gb may be positioned around the neutralizing electrode Gc. The electrodes Ga and Gc may be substantially transparent at the operating spectral region of the interferometer 100. The electrodes Ga, Gb and Gc may comprise e.g. doped polycrystalline silicon, which may be substantially transparent for infrared light LB3.

The electrodes Ga, Gb may generate the electrostatic force F1 when a driving voltage V_{ab} is applied to the electrodes Ga, Gb. The driving voltage V_{ab} may be equal to the voltage difference Vₐ-V_{b}. The voltage may be applied to the electrodes Ga, Gb e.g. via the conductors CON1, CON2 and the terminals N1, N2. The electrode Gc may be galvanically connected to the electrode Ga. The mirror 110 may be flexible and/or the spacer 115 may be mechanically compressible such that the mirror gap d_{FP} may be changed by changing the magnitude of the electrostatic force F1. The magnitude of the electrostatic force F1 may be changed by changing the driving voltage Vₐ-V_{b} (=V_{ab}). The spectrometer 500 may comprise a driving voltage unit 142, which may be arranged to generate the driving voltage V_{ab} according to the control signal S_{d}.

A portion of the mirror 110 between the aperture portion AP1 and spacer 115 may be flexible so as to allow varying the mirror gap d_{FP}. The thickness of the mirror 110 may be selected so as to allow repeated local bending.

Applying a first driving voltage V_{ab} to the electrodes Ga, Gb may cause adjusting the transmission peak P_{FP,k} of the interferometer 100 to a first spectral position (e.g. to the position λ_{P1}), and applying a second different driving voltage V_{ab} to the electrodes Ga, Gb may cause adjusting the transmission peak P_{FP,k} of the interferometer 100 to a second different spectral position (e.g. to the position λ_{P2}).

During normal operation, the space ESPACE1 between the mirrors 110, 120 may be filled with a gas. However, the interferometer 100 may also be operated in vacuum so that the gas pressure in the space ESPACE1 is substantially equal to zero.

The interferometer 100 produced by depositing and etching may be considered to have a substantially monolithic structure. Said interferometer 100 may be e.g. shock resistant and small. The mass of the movable portion MPOR1 may be small, and the interferometer 100 may have a high scanning speed. The movable portion MPOR1 may be rapidly accelerated to the full scanning speed.

Referring to FIG. 11, the spectrometer 500 may comprise an interferometer 100, which has a distance sensor 150 for monitoring the mirror gap d_{FP}. The distance sensor 150 may be e.g. a capacitive sensor, which comprises two or more capacitor plates G1, G2. A first capacitor plate G1 may be attached to the first mirror 110, and a second capacitor plate G2 may be attached to the second mirror 120 so that the distance between the plates G1, G2 depends on the mirror gap d_{FP}. The capacitor plates G1, G2 may together form a capacitor, which has a capacitance C, such that the capacitance C, may depend on the mirror gap d_{FP}. The capacitance value C, may be indicative of the mirror gap d_{FP}. The capacitor plates G1, G2 may be connected to a capacitance monitoring unit 152 e.g. by conductors CONa, CONb. The capacitance monitoring unit 152 may provide a signal S_{d} indicative of the capacitance C, of the sensor 150. The capacitance monitoring unit 152 may provide a signal S_{d} indicative of the mirror gap d_{FP}.

The capacitance monitoring unit 152 may be arranged to measure the capacitance C, e.g. by charging the capacitive sensor 150 with a predetermined current, and by measuring a time needed to charge the sensor 150 to a predetermined voltage. The capacitance monitoring unit 152 may be arranged to measure the capacitance Cₓ e.g. by coupling the capacitive sensor 150 as a part of a resonance circuit, and measuring the resonance frequency of the resonance circuit. The capacitance monitoring unit 152 may be arranged to measure the capacitance Cₓ e.g. by using the capacitive sensor 150 to repetitively transfer charge to a tank capacitor, and counting the number of charge transfer cycles needed to reach a predetermined tank capacitor voltage.

The interferometer 100 may comprise a driving unit 142. The driving unit 142 may e.g. convert a digital driving signal S₁₄₀ into an analog signal suitable for driving the actuator 140. The driving unit 142 may provide e.g. a voltage signal V_{ab} for driving an electrostatic actuator 140, or for driving a piezoelectric actuator 140.

In an embodiment, the control unit CNT1 may be configured to provide a digital driving signal S₁₄₀ for changing the mirror gap d_{FP}, and the control unit CNT1 may be arranged to receive the control signal S_{d}.

The spectral scale of the spectrometer may be stabilized by using a Fabry-Perot etalon, which has fixed mirror spacing. The mirror spacing of the etalon may remain constant during scanning of the interferometer.

The optical cavity of the etalon 50 may consist of one or more solid materials, preferably silicon Si and/or silicon dioxide SiO₂.

The spectrometer 500 may be implemented e.g. in a first mobile unit. Determining spectral positions λ from the control signal values S_{d} may be carried out in the first mobile unit. Determining spectral positions λ from the control signal values S_{d} may be carried out in a second unit, which is separate from the first unit. The second unit may be stationary or mobile. The stationary unit may be implemented e.g. in a server, which may be accessed e.g. via the Internet.

The spectrometer 500 may be used e.g. for remote sensing applications. The spectrometer 500 may be used e.g. for measuring the color of an object OBJ1. The spectrometer 500 may be used e.g. for an absorption measurement, where the transmission peak of the interferometer 100 may be adjusted to a first spectral position to match with an absorption band of an object OBJ1, and the transmission peak of the interferometer 100 may be adjusted to a second spectral position to match with a reference band. The spectrometer 500 may be used e.g. for a fluorescence measurement, where the first spectral position of the transmission peak of the interferometer may be matched with fluorescent light emitted from an object OBJ1, and the second spectral position may be matched with the illuminating light, which induces the fluorescence.

When measuring the reflectance spectrum of an object OBJ1, the object OBJ1 may be illuminated with illuminating light. The illuminating light may have a broad spectrum. In an embodiment, the bandwidth of the illuminating light may be greater than or equal to the detection range of the spectrometer 500.

When broadband light is coupled into the spectrometer, the etalon may provide a filtered spectrum, which has a plurality of filtered peaks at stable spectral positions. The spectral scale of the interferometer 100 may be determined and/or verified by using the filtered peaks. The filtered spectrum may be measured by using the Fabry-Perot interferometer, in order to provide a measured filtered spectrum. The measured spectral intensity distribution M(S_{d}) may substantially reproduce the transmittance peaks of the etalon, and the spectral scale may be determined and/or verified by using the peaks of the distribution M(S_{d}). In particular, the spectral scale of the spectrometer may be stabilized in a situation where the relationship between the mirror gap and the control signal changes e.g. due to variations of operating temperature, mechanical shocks, and/or ageing.

The accuracy of the spectral scale of the interferometer 100 may be determined by the accuracy at which the spectral transmittance T_{E}(λ) of the etalon is known. Δλ_{DEV1} may denote a difference between an actual spectral position of a transmittance peak and a nominal spectral position of said transmittance peak. Δλ_{DEV2} may denote a difference between an actual spectral position of the interferometer and a calibrated spectral position corresponding to said actual spectral position of the interferometer. The deviation Δλ_{DEV2} may be e.g. smaller than 2·Δλ_{PEV1}. The error (Δλ_{DEV2}) of detecting the spectral positions of the peaks of the filtered spectrum may be e.g. smaller than two times the error (Δλ_{DEV1}) of the known spectral positions of the peaks of the transmittance of the etalon.

In an embodiment, light may be coupled into a spectrometer by using one or more optical fibers. For example, light may be guided to the spectrometer from an optical probe by using one or more optical fibers.

The term “light” may refer to electromagnetic radiation in the ultraviolet, visible and/or infrared regime.

A spectral position may be defined e.g. by providing a wavelength value and/or by providing a wavenumber value. The spectral scale may be defined e.g. by using wavelength values and/or by using wavenumber values. The spectral scale may be called e.g. as the wavelength scale. Spectral calibration may also be called e.g. as wavelength calibration. Spectral calibration data may be called e.g. as wavelength calibration data.

For the person skilled in the art, it will be clear that modifications and variations of the devices and the methods according to the present invention are perceivable. The figures are schematic. The particular embodiments described above with reference to the accompanying drawings are illustrative only and not meant to limit the scope of the invention, which is defined by the appended claims.

1. A method for determining spectral calibration data (λ_{cal}(S_{d}), S_{d,cal}(λ)) of a Fabry-Perot interferometer, the method comprising:
forming a plurality of filtered spectral peaks (P′₁, P′₂) by filtering input light (LB1) with a Fabry-Perot etalon such that a first filtered peak (P′₁) corresponds to a first transmittance peak (P₁) of the etalon, and such that a second filtered peak (P′₂) corresponds to a second transmittance peak (P₁) of the etalon,
using the Fabry-Perot interferometer for measuring a spectral intensity distribution (M(S_{d})) of the filtered spectral peaks (P′₁, P′₂), wherein the spectral intensity distribution (M(S_{d})) is measured by varying the mirror gap (d_{FP}) of the Fabry-Perot interferometer and by providing a control signal (S_{d}) indicative of the mirror gap (d_{FP}), and
determining the spectral calibration data (λ_{cal}(S_{d}), S_{d,cal}(λ)) by matching the measured spectral intensity distribution (M(S_{d})) with the spectral transmittance (T_{E}(λ)) of the etalon

2. The method of claim 1, wherein the spectral calibration data (λ_{cal}(S_{d}), S_{d,cal}(λ)) determines a relation for obtaining spectral positions (λ) from values of the control signal (S_{d}).

3. The method of claim 1, wherein the minimum spectral transmittance (T_{E,MIN}) of the etalon is lower than or equal to 90% of the maximum spectral transmittance (T_{E,MAX}) of the etalon.

4. The method according to claim 1, wherein first spectral calibration data (λ_{cal}(S_{d}), S_{d,cal}(λ)) is determined by using input light (LB1) obtained from an object (OBJ1), and a calibrated spectrum (I₁(λ)) of an object (OBJ1) is determined from a measured spectral intensity distribution M(S_{d}) by using said first spectral calibration data (λ_{cal}(S_{d}).

5. The method according to claim 1, further comprising monitoring the temperature of the etalon, and determining a first spectral position (λ_{P1}) of the first transmittance peak (P1) based on the temperature of the etalon.

6. The method according to claim 1, wherein the Fabry-Perot interferometer comprises an electrostatic actuator, the mirror gap (d_{FP}) is varied by changing a driving voltage (V_{ab}) applied to the electrostatic actuator, and the driving voltage (V_{ab}) is changed according to the control signal (S_{d}).

7. The method according to claim 1, wherein the interferometer comprises a capacitive sensor (Ga, Gd) arranged to provide the control signal (S_{d}) by monitoring the mirror gap (d_{FP}) of the interferometer.

8. The method according to claim 1, further comprising:
analyzing the spectral intensity distribution M(S_{d}) in order to determine a first control signal value (S_{d1}) associated with a first mirror gap (d_{FP}) when the transmission peak (P_{FP,k}) of the interferometer substantially coincides with the first filtered peak (P′₁),
analyzing the spectral intensity distribution M(S_{d}) in order to determine a second control signal value (S_{d2}) associated with a second mirror gap (d_{FP}) when the transmission peak (P_{Fp,k}) of the interferometer substantially coincides with the second filtered peak (P′₂),
forming a first association (λ_{P1},SS_{d1}) between the first control signal value (S_{d1}) and the spectral position (λ_{P1}) of the first transmittance peak (P1) of the etalon,
forming a second association (λ_{P2}, S_{d2}) between the second control signal value (S_{d2}) and the spectral position (λ_{P2}) of the second transmittance peak (P2) of the etalon, and
determining the spectral calibration data (λ_{cal}(S_{d})) based on the first association (λ_{P1}, S_{d1}) and based on the second association (λ_{P2}, S_{d2}).

9. The method according to claim 1, wherein the measured spectral intensity distribution M(S_{d}) is compared with the spectral transmittance (T_{E}(λ)) of the etalon by using cross-correlation analysis.

10. The method according to claim 1, the method further comprising:
monitoring an operating temperature of the etalon by means of a temperature sensor
providing a temperature signal (S_{TEMP}) indicative of the operating temperature of the etalon and
determining a spectral position (λ_{P1}) of a transmittance peak (P1) based on the temperature of the etalon.

11. The method according to claim 1, wherein a signal power transmitted in the blocking bands is in a range between 1% and 30% of an original signal power.

12. The method according to claim 1, wherein minimum transmittance peaks and maximum transmittance peaks of the etalon are used for determining spectral calibration data (λ_{cal}(S_{d}), S_{d,cal}(λ)) of a Fabry-Perot interferometer.

13. An apparatus comprising at least one processor (CNT1), a memory (MEM5) including computer program code (PROG1), the memory (MEM5) and the computer program code (PROG1) configured to, with the at least one processor (CNT1), cause the apparatus to perform a method for determining spectral calibration data (λ_{cal}(S_{d}), S_{d,cal}(λ))of a Fabry-Perot interferometer, the method comprising:
forming a plurality of filtered spectral peaks (P′₁, P′₂) by filtering input light (LB1) with a Fabry-Perot etalon such that a first filtered peak (P′₁) corresponds to a first transmittance peak (P₁) of the etalon, and such that a second filtered peak (P′₂) corresponds to a second transmittance peak (P₁) of the etalon,
using the Fabry-Perot interferometer for measuring a spectral intensity distribution (M(S_{d})) of the filtered spectral peaks (P′₁, P′₂), wherein the spectral intensity distribution (M(S_{d})) is measured by varying the mirror gap (d_{FP}) of the Fabry-Perot interferometer, and by providing a control signal (S_{d}) indicative of the mirror gap (d_{FP}), and
determining the spectral calibration data (λ_{cal}(S_{d}), S_{d,cal}(λ)) by matching the measured spectral intensity distribution (M(S_{d}) with the spectral transmittance (T_{E}(λ)) of the etalon.

14. An apparatus comprising:
an etalon to form a plurality of filtered spectral peaks (P′₁, P′₂) by filtering input light (LB1) such that a first filtered peak (P′₁) corresponds to a first transmittance peak (P₁) of the etalon, and such that a second filtered peak (P′₂) corresponds to a second transmittance peak (P₁) of the etalon, and
a Fabry-Perot interferometer to measure a spectral intensity distribution M(S_{d}) of the filtered spectral peaks (P′₁, P′₂) by varying the mirror gap (d_{FP}) of the Fabry-Perot interferometer,
wherein the apparatus is arranged:
to provide a control signal (S_{d}) indicative of the mirror gap (d_{FP}), and
to determine spectral calibration data (λ_{cal}(S_{d})), (S_{d,cal}(λ)) by matching the measured spectral intensity distribution M(S_{d}) with the spectral transmittance (T_{E}(λ)) of the etalon.

15. The apparatus according to claim 14, wherein the optical cavity of the etalon consists of one or more solid materials.

16. The apparatus claim 14 according to claim 14, further comprising a temperature sensor to monitor the temperature of etalon.

17. The apparatus according to claim 14, wherein an empty space (ESPACE1) between the mirrors of interferometer has been formed by etching.

18. The apparatus according to claim 14, wherein the Fabry-Perot interferometer comprises an electrostatic actuator for varying the mirror gap (d_{FP}) of the Fabry-Perot interferometer.

19. The apparatus according to claim 14, comprising a temperature sensor configured to monitor an operating temperature of the etalon.

20. The apparatus according to claim 14, comprising means for providing a temperature signal (S_{TEMP}) indicative of the operating temperature of the etalon.

21. The apparatus according to claim 14, further comprising means for determining a spectral position (λp₁) of the first transmittance peak (P1) based on the temperature of the etalon.

22. The apparatus according to claim 14, further comprising a computer readable medium having stored thereon a set of computer implementable instruction capable of causing a processor to determine spectral calibration data (λ_{cal}(S_{d}), S_{d,cal}(λ)) of a Fabry-Perot interferometer.

23. The apparatus according to claim 14, further comprising a non-transitory computer readable medium having stored thereon a set of computer implementable instruction capable of causing a processor to determine spectral calibration data (λ_{cal}(S_{d}), S_{d,cal}(λ)) of a Fabry-Perot interferometer based on an operating temperature of the etalon.

24. The apparatus according to claim 14, wherein the Fabry-Perot etalon is configured such that specific wavelengths of transmission peaks of the etalon and a spectral resolution of the apparatus are synchronized.

25. The apparatus according to claim 14, wherein the etalon is configured such that a signal power transmitted in the blocking bands is in the range between 1% and 30% of an original signal power.
